(19) United States
(12) Patent Application Publication
(10) Pub. No.: US 2026/0365908 A1
(43) Pub. Date: Nov. 19, 2026

(54) SEALANT COMPOSITIONS COMPRISING VOLCANIC ASH, SUBTERRANEAN OPERATION FLUIDS THEREOF, AND RELATED METHODS

(71) Applicant: SAUDI ARABIAN OIL COMPANY, Dhahran (SA)

(72) Inventors: Khawlah ALANQARI, Dhahran (SA); Abdullah AL-YAMI, Dhahran (SA); Abdulaziz ALHELAL, Dhahran (SA)

(73) Assignee: SAUDI ARABIAN OIL COMPANY, Dhahran (SA)

(21) Appl. No.: 19/208,968

(22) Filed: May 15, 2025

(51) Int. Cl. C09K 8/502; E21B 21/00; E21B 33/138

(52) U.S. Cl. CPC C09K 8/502; E21B 21/003; E21B 33/138

(57) ABSTRACT

Sealant compositions and methods thereof. Sealant compositions include: an epoxy resin system including: an epoxy resin portion including: at least one epoxy resin; and at least one nitrogenous curing agent; and a Saudi Arabian volcanic ash. Sealant compositions may further include a diluent, an emulsifier, and/or a weighting agent. Method include: introducing the sealant composition into a wellbore within a subterranean formation; and allowing the sealant composition to cure. Methods may include introducing the sealant composition into a zone of interest within the subterranean formation via the wellbore and selected from the group consisting of a depleted zone, a zone of low pressure, a lost circulation zone, a fracture zone, and any combination thereof; and curing the sealant composition therein. Methods may include introducing the sealant composition into the annulus between the wall of the wellbore and a casing disposed therein, and curing the sealant composition therein.

### FIELD OF THE DISCLOSURE

The present disclosure relates generally to sealant compositions, subterranean operation fluids thereof, and related methods; more particularly, the present disclosure relates to sealant compositions comprising an epoxy resin system and volcanic ash, subterranean operation fluids thereof, and related methods.

### BACKGROUND

The production of crude oil and other hydrocarbons begins with the drilling of a wellbore through a subterranean formation and into a hydrocarbon reservoir. Drilling of a wellbore generally involves circulating a drilling fluid (or drilling mud) from a surface location of the wellbore to a downhole location through a drill string. The drilling fluid exits through ports (or jets) in a drill bit, which bores through the formation and forms the wellbore. The drilling fluid aids in cooling and lubricating the drill bit and further picks up cuttings and carries the cuttings up an annulus (also referred to herein as an annular area) formed between an inner wall of the wellbore and an outer wall of the drill string. The drilling fluid and the cuttings flow through the annulus to the surface, where the cuttings are separated from the fluid. For various environmental, sustainability, and practical reasons, aqueous-based drilling fluids may be preferred for wellbore drilling operations in place of oil-based fluids.

Once the wellbore, or a desired section of a wellbore is complete, it may be isolated from the surrounding subterranean formation using a cementing operation. After drilling, the drill string is replaced by casing, essentially a pipe that creates a central area for flow of liquids with an annulus between the outer wall of the casing and the surrounding formation wellbore walls. During a cementing operation, a cement sheath is placed within that annulus between the subterranean formation and the outer wall of the casing. The cement sheath is formed by pumping a cement slurry down into the casing interior, out through the bottom end of the casing, and up into the annulus between the exterior casing wall and the formation face of the wellbore (known as reverse cementing). The cement slurry then cures in the annular space, thereby forming a sheath of hardened cement that, among other functions, supports and positions the casing in the wellbore and bonds the exterior surface of the casing to the subterranean formation. The cement also prevents hydrocarbon fluid from flowing uphole from a hydrocarbon producing zone to the surface and in the annulus between the casing and the wellbore wall. Without the cement, or in instances when cement has failed, hydrocarbons are known to migrate to the surface and then present a safety hazard to operations personnel.

Cement slurries used in the oil and gas industry include primary, remedial, squeeze, and plug cementing techniques to place cement sheaths, for instance, in an annulus between a tubular (e.g., a casing) and a wall of the wellbore, for well repairs, well stability, or for well abandonment (i.e., sealing an old well to eliminate safety hazards). These cement slurries should be able to consistently perform throughout operations (e.g., pumping) and over a wide range of temperatures and conditions as cement cure in an oil and gas well may be vulnerable to radial stresses imposed by pressure and temperature fluctuations. Such vulnerability, depending on its severity, can result in mechanical failure. After mechanical failure, an expensive remedial operation like squeezing resin or micro-cement may be required to repair cracks in the wellbore cement sheath. Inadequate sealing of the original cracks or inadequate remedial operations may cause a fire hazard, an environmental hazard, a lack of zonal isolation, or a loss of pressure behind casing. Depending on the severity, these risks may lead to catastrophic accidents, failures, or well-abandonment.

The transition between a drilling operation and a cementing operation may further result in various issues that require additional remedial steps, such as for example, operator costs associated with time, economic expenditures, and equipment wear and tear. For example, after performing a drilling operation, residual aqueous-based drilling fluid may remain within the drilled wellbore, presenting significant challenges related to, for example, zonal isolation due to unstable and/or poor cement bonding, mud channeling, or other fluid migration-related interferences.

Indeed, fluid loss (or lost circulation) is a common way that drilling fluid is lost into the surrounding subterranean formation. Fluid loss can occur in various subterranean formations, such as naturally fractured formations, cavernous formations, and highly permeable formations (e.g., formations having a permeability greater than 500 millidarcy), regardless of the wellbore geometry (e.g., horizontal, vertical, deviated, or otherwise tortuous). While some fluid loss is expected, excessive fluid loss is not desirable from a safety, an economical, or an environmental point of view. Lost circulation is associated with problems with well control, borehole instability, pipe sticking, unsuccessful production tests, poor hydrocarbon production after well completion, and formation damage due to plugging of pores and pore throats by mud particles. In extreme cases, lost circulation problems may force abandonment of a well.

Lost circulation can be categorized by the amount of fluid or mud lost as seepage type, moderate type, severe type, and total loss. The extent of the fluid loss and the ability to control the lost circulation using lost circulation materials (“LCMs”) depends on the formation type where lost circulation occurs. One method that has been developed to control lost circulation involves the placement of LCMs into a lost circulation zone (i.e., the sections of a formation into which drilling fluid may be lost). Conventional LCMs may include fibrous, lamellated or granular materials. For a number of reasons, use of LCMs may not provide a desirable level of lost circulation control in all circumstances.

In view of the aforementioned, a need exists for an ecologically and economically friendly sealant system for use in the oil and gas industry with improved fluid loss control and/or cement sheath stabilization during subterranean operations.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to various embodiments consistent with the present disclosure, methods are provided comprising: introducing a sealant composition into a wellbore within a subterranean formation, wherein the sealant composition comprises: an epoxy resin system comprising: an epoxy resin portion comprising at least one epoxy resin; and at least one nitrogenous curing agent; and a Saudi Arabian volcanic ash; and allowing the sealant composition to cure.

According to various embodiments consistent with the present disclosure sealant composition are provided comprising: an epoxy resin system comprising: an epoxy resin portion comprising: at least one epoxy resin; and at least one nitrogenous curing agent; and a Saudi Arabian volcanic ash.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

To easily identify the discussion of any particular element or act, the most significant digit or digits in a reference number refer to the figure number in which that element is first introduced.

FIGS. 1A-1B show a schematic illustration of losses due to fractured substrate formation by which the loss of drilling fluid can take place, as described below in the Examples. FIG. 1A shows a schematic illustration of loss zones within a subterranean formation wherein the loss events can possibly occur, e.g., through natural fractures. FIG. 1B shows a schematic illustration of a subterranean formation in which an epoxy resin system-volcanic ash-based sealant composition is formed within a loss zone for use as a lost circulation material.

FIG. 2 shows an epoxy resin system-volcanic ash-based sealant composition from Table 7 comprising 9.5 weight percent (wt %) volcanic ash, shown before setting (left) and after thickening (right), indicating strong gelling.

FIG. 3 shows the thickened composition of FIG. 2 after heating in a water bath (120 °F) for 24 hours, indicating curing into a hard rigid material.

### DETAILED DESCRIPTION

Embodiments of the present disclosure will now be described in detail with reference to the accompanying Figures. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments of the present disclosure generally relate to preventing lost circulation during well drilling or cementing operations. The materials described as suitable for use herein provide stable masses that are suitable for preventing lost circulation during drilling and for providing a stable cement sheath that seals the outer wall of the casing to the walls of the drilled wellbore.

In an aspect, the present disclosure provides improved sealant compositions and related methods for mitigating fluid flow into lost circulation zones within a subterranean formation, where the sealant is capable of acting as a lost circulation material (“LCM”), during drilling operations, cementing operations, the like, and any combination thereof. Sealant compositions may be suitable for sealing formations having different types of fractures. Sealant compositions as disclosed herein provide an improved, environmentally acceptable, customized high-performance system that can be used in water-based mud systems and oil-based mud systems, enabling wells to be drilled with high pressure high temperature wells, while reducing fluid loss into subterranean formations.

In a further aspect, the present disclosure provides sealant compositions and related methods for forming cement sheaths within an annulus of a wellbore, during primary, remedial, squeeze, or plug cementing techniques, the like, or any combination thereof. Sealant compositions as disclosed herein can further be used as cement slurries, to position and stabilize a casing within a wellbore, while preventing the flow of fluids between formations, between a formation and the surface, as well as preventing gas or fluids from migrating to the surface. This newly designed system helps the operator increase operational efficiency by minimizing the risk of differential sticking, reducing downhole losses, improving wellbore stability, and reducing the cost of chemical usage, while also being an eco-friendly material.

As used herein, the term “subterranean formation,” and grammatical variants thereof, refers to naturally occurring rock beneath the Earth's surface, including subsea surfaces. As used herein, the terms “formation matrix,” “matrix,” and grammatical variations thereof, refer to the variety of natural rock which makes up a subterranean formation, including, but not limited to, carbonate-based rock (e.g., calcium carbonate (CaCO₃)), calcium magnesium carbonate (CaMg(CO₃)₂) (also referred to as dolomite), sandstone-based rock comprising clays (e.g., smectite, illite, kaolinite, chlorite, and the like), each of which include minerals (e.g., siliceous material) the like, and any combination thereof. The subterranean formations described herein encompass reservoir zones (i.e., zones comprising hydrocarbons, also referred to herein as “hydrocarbon reservoirs”) and non-reservoir zones (i.e., zones that do not include hydrocarbons, such as water-producing zones).

As used herein, the terms “subterranean operation” and “upstream operation,” and grammatical variants thereof, refer to any operation (e.g., drilling, completion, stimulation, enhanced recovery, production, and waste storage) involved in production of petroleum, natural gas, as well as other resources, such as water or helium, from a subterranean formation. A subterranean formation may contain an existing injection well, an existing production well, or a deep abandoned shallow single and/or multi-lateral well.

As used herein, the terms “well,” “wellbore,” and grammatical variants thereof, refer to a drilled hole or borehole penetrating a subterranean formation, which may be cased (cemented) or uncased (open hole). A wellbore may be of any geometry, including vertical, horizontal, deviated, or otherwise tortuous.

As used herein, the term “downhole,” and grammatical variants thereof, refers to the subsurface point of greatest penetration or depth in a wellbore.

As used herein, the term “subterranean operation fluid,” and grammatical variants thereof, refers to gaseous fluids, aqueous or oil-based liquids, and/or aqueous or oil-based muds suitable for use in subterranean operations in subterranean formations. For example, a drilling operation may use a liquid-based or mud-based drilling fluid, a cementing operation may use a cement slurry, a fluid loss control operation may use a liquid-based or mud-based drilling fluid or a drilling pill, or an enhanced recovery operation may include a fracturing fluid.

As used herein, the term “lost circulation zone,” and grammatical variants thereof, refers to a location within a wellbore in which fluid loss occurs into a subterranean formation. A lost circulation zone may encompass an area encountered during various subterranean formation operations (e.g., drilling operations, cementing operations) where a volume of a treatment fluid is imbibed by a subterranean formation through a wellbore wall. A rate of loss of 1 to 10 barrels per hour (bbl/h) is characterized as seepage-loss that may occur in any formation; a rate of loss of 10 to less than 500 bbl/h is characterized as moderate-loss that may occur in porous formations or those having relatively small natural or induced fractures; and a rate of loss of equal to or greater than 500 bbl/h is characterized as severe-loss that may occur in highly permeable formations or those having relatively large natural or induced fractures. Severe-loss may include total fluid loss and can result in complete abandonment of a well.

As used herein, the term “formation temperature conditions,” and grammatical variants thereof, refer to downhole temperature conditions, i.e., temperature conditions of from 49 °C (120 °F) to about 204 °C (400 °F), including all temperature values and subranges therebetween (e.g., at least about 66 °F (150 °F), at least about 93 °C (200 °F), at least about 121 °C (250 °F), at least about 149 °C (300 °F), or at least about 177 °C (350 °F), or from about 66 °F (150 °F) to about 177 °C (350 °F), or from about 93 °C (200 °F) to about 149 °C (300 °F), or from about 121 °C (250 °F)).

### Sealant Compositions

Sealant compositions of the present disclosure may incorporate at least two main components: (i) an epoxy resin system comprising at least (ia) an epoxy resin portion comprising at least one epoxy resin, and (ib) a curing agent portion comprising at least one nitrogenous curing agent; and (ii) a volcanic ash. The epoxy resin portion may further comprise at least one diluent. The epoxy resin portion may further comprise at least one emulsifying agent, weighting agent, the like, or any combination thereof. The curing agent portion may further comprise at least one curing additive. Sealant compositions of the present disclosure may comprise at least one epoxy resin, a nitrogenous curing agent, and volcanic ash. Sealant composition may exclude an aqueous carrier fluid. Sealant composition may exclude an alkaline silicate, e.g., an alkali metal silicate. Sealant compositions of the present disclosure may comprise a non-aqueous carrier fluid. Sealant compositions of the present disclosure may consist of or consist essentially of the epoxy resin system and the volcanic ash.

Sealant compositions may be flowable upon activation for a sufficient time, e.g., a sufficient time for pumping of said sealant compositions and/or for use of said sealant compositions for drilling operations, cementing operations, for fluid loss control operations, the like, and any combination thereof. Sealant compositions of the present disclosure may be flowable for a sufficient time, e.g., suitable for pumping, use during drilling operations in a wellbore, use during cementing operations, use during fluid loss control operations, use during enhanced recovery operations, the like, and any combination thereof. After a sufficient time, sealant compositions of the present disclosure may be cured to a semi-solid or solid state capable of sealing lost circulation zones in a subterranean formation, cementing the annulus of the wellbore, or any combination thereof.

As used herein, the terms “flowable,” “flowability,” and grammatical variants thereof, refer to the ability of sealant compositions of the present disclosure to be pumped and to flow into a wellbore, as required for use as a drilling fluid, a cementing fluid, the like, or any combination thereof. As used herein, flowable sealant compositions are characterized as having a flowable liquid-phase that may include various solid and/or gaseous states of matter dispersed throughout which flow with the flowable liquid-phase. The flowability of sealant compositions can be determined by measuring various rheological properties of the sealant compositions.

Flowable sealant compositions of the present disclosure may be in an inactivated state. As used herein, the terms “inactivated” or “inactivated state,” and grammatical variants thereof, refer to sealant compositions of the present disclosure in which substantial curing or other polymerization reactions have yet to occur, either by prevention of contact between the one or more nitrogenous curing agents with any other components of the sealant composition or by addition of one or more cure retarding agents capable of preventing, delaying, or inhibiting a curing reaction or other polymerization reactions therein, or for which, after contact has been made between the one or more nitrogenous curing agents and the other components of a sealant composition, insufficient time has passed, such that substantial curing or other polymerization reactions have not occurred. As used herein, the term “substantial,” and grammatical variants thereof, generally refer to an amount of curing or other polymerization reactions that produce a change of greater than 5 percent (%) in any property (e.g., weight percent (wt %), rheology, density, the like, or any combination thereof). For example, a property of any component of sealant compositions will refer to the property prior to contact with any curing agents, while a property of sealant compositions, unless otherwise indicated, refers to the property of an inactivated sealant composition (i.e., the property as measured immediately after addition of the nitrogenous curing agent and before substantial curing has occurred).

As used herein, the terms “activated” and “activated state,” and grammatical variants thereof, refer to sealant compositions of the present disclosure in which a substantial curing reaction has occurred within sealant compositions by contact between any curing agents and the other components of the sealant composition, and/or by loss, removal, and/or inhibition of any cure retarding agents, and/or by addition of one or more accelerators capable of accelerating the setting reaction, and/or by subjecting an inactivated sealant composition to heat (e.g., at room temperature or above, e.g., at 100 °F or above, at formation temperature conditions (e.g., from about 120 °F to about 400 °F) or above).

Sealant compositions of the present disclosure may undergo various curing reactions. As used herein, the terms “cure,” “curing,” and grammatical variations therein, generally refer to reactions between epoxy-functional materials (i.e., epoxy-functional resins, epoxy-functional diluents, and any combination thereof) and co-reactants (e.g., materials comprising hydroxyl groups, amine groups, carboxylic acids, thiols, and the like) which undergo crosslinking upon initiation with curing agents, which may or may not become part of the cross-linked structure. Curing of sealant compositions of the present disclosure may comprise a first transition from the flowable liquid-phase to a thickened-phase. As used herein, the term “thickening time,” and grammatical variants thereof, generally refers to the duration of time that sealant compositions remain in a fluid state capable of being pumped (i.e., flowable). With time, sealant compositions undergo a second transition from the intermediate thickened-phase to a semi-solid phase (also referred to herein as a semi-solid state). As used in this disclosure, the term “semi-solid” refers to a phase (aka, state) of the sealant compositions that is between a liquid material and a solid material in which the composition exhibits high elasticity and flexibility. In the semi-solid state, sealant compositions may be easily deformed but may return to shape upon releasing the deforming force.

With more time, cured sealant compositions may undergo a third transition into a solid phase (also referred to herein as a solid state). As used herein, the term “solid,” and grammatical variations thereof, generally refers to a state of the sealant compositions that is a rigid material in which the composition exhibits zero or negligible deformation. As used herein, the term “solidified sealant compositions,” and grammatical variants thereof, refer to any of the cured phases (either the elastic semi-solid or the rigid solid phases) that form after activation of sealant compositions of the present disclosure. As used herein, the terms “setting time,” “curing time,” and grammatical variations thereof, refer to the duration of time for sealant compositions to form solidified sealant compositions (e.g., either the semi-solid or the solid phases). A solidified sealant composition of the present disclosure (also referred to herein as a cured or a set sealant composition), whether an elastic semi-solid or a rigid solid, may be suitable for sealing an annulus of a wellbore, for sealing lost circulation zones within a subterranean formation, the like, or any combination thereof.

### Volcanic Ash

Volcanic ash of the present disclosure may be added to the sealant compositions described herein to act as a weighting material in the sealant composition, and to aid the sealant composition in forming a rigid material with the epoxy resin system therein. As used herein, the term “volcanic ash,” and grammatical variations thereof, generally refers to a particulate mixture of rock, mineral, and glass fragments ejected from a volcano during a volcanic eruption. Volcanic ash is an abundant material generally regarded as an environmental and health hazard requiring cleanup and disposal. Reuse of natural products such as volcanic ash is a promising way to attain green and sustained development.

Volcanic ash of the present disclosure may have various chemical compositions. Volcanic ash of the present disclosure may be Saudi Arabian volcanic ash (i.e., ejected from a Saudi Arabian volcano). The elemental composition of volcanic ash may be determined by elemental analysis techniques such as Wavelength Dispersive X-ray Fluorescence (WDXRF). The elemental composition of volcanic ash may include primarily O, Si, and Al, and lesser quantities of one or more of Fe, Ca, Mg, and Na, based on the total elemental composition of volcanic ash. The elemental composition of volcanic ash may primarily include from about 20 wt % to about 50 wt %, including all wt % values and subsets therebetween, of each of O and Si, based on the total elemental weight of volcanic ash (e.g., from about 20 wt % to about 45 wt %, from about 20 wt % to about 40 wt %, from about 20 wt % to about 35 wt %, from about 20 wt % to about 30 wt %, from about 20 wt % to about 25 wt %, from about 25 wt % to about 50 wt %, from about 25 wt % to about 45 wt %, from about 25 wt % to about 40 wt %, from about 25 wt % to about 30 wt %, from about 30 wt % to about 50 wt %, from about 30 wt % to about 45 wt %, from about 30 wt % to about 40 wt %, from about 30 wt % to about 35 wt %, from about 35 wt % to about 50 wt %, from about 35 wt % to about 45 wt %, from about 35 wt % to about 40 wt %). The elemental composition of volcanic ash may comprise from about 40 wt % to about 50 wt % of O, and from about 20 wt % to about 30 wt % OF Si.

Volcanic ash may further include the elements of Al, Fe, Ca, Mg, and Na, each present at from about 2 wt % to about 10 wt %, including all wt % values and subsets therebetween, based on the total elemental composition of volcanic ash (e.g., from about 2 wt % to about 9 wt %, from about 2 wt % to about 7 wt %, from about 2 wt % to about 5 wt %, from about 2 wt % to about 3 wt %, from about 3 wt % to about 10 wt %, from about 3 wt % to about 8 wt %, from about 3 wt % to about 6 wt %, from about 3 wt % to about 4 wt %, from about 4 wt % to about 9 wt %, from about 4 wt % to about 7 wt %, from about 4 wt % to about 5 wt %, from about 5 wt % to about 10 wt %, from about 5 wt % to about 8 wt %, from about 5 wt % to about 6 wt %, from about 6 wt % to about 9 wt %, from about 6 wt % to about 7 wt %, from about 7 wt % to about 10 wt %, from about 7 wt % to about 8 wt %, from about 8 wt % to about 9 wt %, from about 9 wt % to about 10 wt %). Volcanic ash may comprise from about 5 wt % to about 15 wt % of Al.

Volcanic ash may include a mixture of amorphous and crystalline mineral material, as measured, for example, by x-ray diffraction (XRD) analysis. Volcanic ash may include 50 wt % or greater of amorphous material, including all wt % values and subsets therebetween (e.g., from about 50 wt % to about 90 wt %, from about 50 wt % to about 85 wt %, from about 50 wt % to about 80 wt %, from about 50 wt % to about 70 wt %, from about 50 wt % to about 60 wt %, from about 60 wt % to about 90 wt %, from about 60 wt % to about 85 wt %, from about 60 wt % to about 80 wt %, from about 60 wt % to about 70 wt %, from about 70 wt % to about 90 wt %, from about 70 wt % to about 85 wt %, from about 70 wt % to about 80 wt %, from about 80 wt % to about 90 wt %, from about 80 wt % to about 85 wt %, from about 85 wt % to about 90 wt % wt %, about 60 wt % or greater, about 70 wt % or greater, about 80 wt % or greater, or about 85 wt % or greater). Volcanic ash may include about 70 wt % of amorphous material.

Volcanic ash may include less than 50 wt % of a mixture of crystalline minerals including one or more of labradorite (i.e., Ca_{0.65}Na_{0.32}(Al_{1.62}Si_{2.38}O₈)), augite (i.e., Ca(Fe,Mg)Si₂O₆), forsterite (i.e., Mg₂SiO₄), and any combination thereof. Volcanic ash may comprise at least 10 wt % of labradorite, and at least 5 wt % of each of augite and forsterite.

Volcanic ash may include untreated volcanic ash. As used in the disclosure, the term “untreated” or “without treating” refers to not treated with alkali or acid, not bleached, not chemically altered, not oxidized, and without any extraction or reaction process other than possibly drying of water. The term “untreated” or “without treatments” does not encompass grinding or heating to remove moisture but does encompass chemical or other processes that may change the characteristics or properties of the volcanic ash. In accordance with this definition, volcanic ash that is treated may behave in a manner different than its original starting material. Volcanic ash may undergo one or more treatment processes before, during, or after washing, drying, crushing, grinding, or any other processing. Suitable examples of treatment processes include, but are not limited to, the like, and any combination thereof.

Volcanic ash of the present disclosure may have various particle sizes and/or particle size distributions. Volcanic ash may be further processed in order to achieve a desired particle size and/or particle size distribution. Volcanic ash may be prepared by various pulverization methods. As used herein, the terms “pulverization,” “pulverizing,” and grammatical variations thereof, refer generally to reducing a material to very small particles. Suitable pulverizing methods may include, but are not limited to, crushing, pressing, grinding, sieving, the like, and any combination thereof. Volcanic ash may be washed and/or dried (e.g., air dried, oven dried, or the like) prior to pulverization. Volcanic ash may be pulverized by grinding in a suitable grinder, e.g., an industrial grinder. Volcanic ash may be crushed to a first size before being ground to a smaller second size. Volcanic ash may include, consist of, or consist essentially of, crushed volcanic ash, ground volcanic ash, or any combination thereof.

Volcanic ash may have various particle sizes, shapes, and/or distributions after pulverization. Volcanic ash may include a mono-modal or multi-modal particle size (e.g., diameter) distribution. Pulverized volcanic ash may be segregated to produce volcanic ash having a specific size or size distribution. Volcanic ash may be sifted using sieves having a sieve opening size that produces the desired particle size. Volcanic ash may have a fine average particle size (e.g., diameter), i.e., where 80 percent (%) of the particles have a particle size less than 60 m, including all values and ranges therebetween (e.g., less than 55 m, less than 50 m, or less than m), as determined, for example, by sieve granulometry. Depending on the size and/or size distribution, the volcanic ash may seal gaps of various sizes when used to mitigate or prevent lost circulation in a well. Volcanic ash may be generally granular shaped with various size ranges to enable the volcanic ash to enter porous and permeable paths, cracks, and fractures in a formation causing mud losses in order to produce an effective seal, barrier, or other preventative to further mud losses.

Volcanic ash may be susceptible to various other curing or polymerization reactions, e.g., reactions of the volcanic ash of the present disclosure with materials or compounds present in a subterranean formation into which the sealant compositions are introduced or as part of a subterranean operation fluid comprising the sealant compositions, such reactions including, but not limited to, pozzolanic reactions, geopolymerization reactions, the like, and any combination thereof. As used herein, the term “pozzolanic reaction,” and grammatical variations thereof, refer to the polymerization reaction of finely ground siliceous and aluminous materials with calcium hydroxide in the presence of water at room temperatures or with heat to form calcium silicates hydrates (CSH) and calcium aluminates hydrates (CAH), to form cements. As used herein, the term “geopolymerization,” and grammatical variants thereof, refer to the polymerization of an aluminosilicate material by an alkaline activator, generally at pH 12-13, in the presence of heat, thus forming a geopolymer. As used herein, the term “geopolymer,” and grammatical variants thereof, refer to a solid, three-dimensional tetrahedral silicon oxide network in which aluminum is substituted for silicon in at least a portion of the tetrahedral positions. Geopolymers may include linkages selected from: Si—S; Si—O; Al—O; Si—O—Si; Al—O—Al; Si—O—Al; Si—O—Al—O; Si—O—Al—O—Si—O; Si—O—Al—O—Si—O—Si—O; and any combination thereof. Sealant compositions may exclude alkaline activators capable of initiating pozzolanic reactions, geopolymerization reactions, the like, and any combination thereof.

Sealant compositions of the present disclosure may include various quantities of volcanic ash. Sealant compositions may include from about 0.1 wt % to about 50 wt % of volcanic ash, including all wt % values and subsets therebetween, based on the total weight of the sealant composition (e.g., from about 0.1 wt % to about 40 wt %, from about 0.1 wt % to about 30 wt %, from about 0.1 wt % to about 20 wt %, from about 0.1 wt % to about 10 wt %, from about 0.1 to about 5 wt %, from about 0.1 wt % to about 1 wt %, from about 1 wt % to about 50 wt %, from about 1 wt % to about 40 wt %, from about 1 wt % to about 30 wt %, from about 1 wt % to about 20 wt %, from about 1 wt % to about 10 wt %, from about 1 to about 5 wt %, from about 5 wt % to about 50 wt %, from about 5 wt % to about 40 wt %, from about 5 wt % to about 30 wt %, from about 5 wt % to about 20 wt %, from about 5 wt % to about 10 wt %, from about 10 wt % to about 50 wt %, from about 10 wt % to about 40 wt %, from about 10 wt % to about 30 wt %, from about 10 wt % to about 20 wt %, from about 20 wt % to about 50 wt %, from about 20 wt % to about 40 wt %, from about 20 wt % to about 30 wt %, from about 30 wt % to about 50 wt %, from about 30 wt % to about 40 wt %, from about 40 wt % to about 50 wt %). Sealant compositions may include from about 5 wt % to about 20 wt %.

### Epoxy Resin System

Epoxy resin systems of the present disclosure may include at least two main components: an epoxy resin portion and a curing agent portion. Together, these components form a tough and dense composite upon setting for use in oil well sealing operations, such as cementing operations, lost circulation material (LCM) operations, the like, and any combination thereof.

Sealant compositions of the present disclosure may include various quantities of an epoxy resin system. Sealant compositions may include from about 50 weight percent (wt %) to about 99.9 wt % of an epoxy resin system, including all wt % values and subsets therebetween, based on the total weight of the sealant composition (e.g., from about 50 wt % to about 95 wt %, from about 50 wt % to about 90 wt %, from about 50 wt % to about 80 wt %, from about 50 wt % to about 70 wt %, from about 50 wt % to about 60 wt %, from about 60 wt % to about 99.9 wt %, from about 60 wt % to about 95 wt %, from about 60 wt % to about 90 wt %, from about 60 wt % to about 80 wt %, from about 60 wt % to about 70 wt %, from about 70 wt % to about 99.9 wt %, from about 70 wt % to about 95 wt %, from about 70 wt % to about 90 wt %, from about 70 wt % to about 80 wt %, from about 80 wt % to about 99.5 wt %, from about 80 wt % to about 95 wt %, from about 80 wt % to about 90 wt %, from about 90 wt % to about 99.9 wt %, from about 90 wt % to about 95 wt %, or from about 95 wt % to about 99.5 wt %).

### Epoxy Resin Portion

As used in this disclosure, the term “epoxy resin portion” comprises at least one or more epoxy resins of the present disclosure. Epoxy resin portions may also comprise one or more diluents of the present disclosure (e.g., reactive diluents (e.g., functional reactive diluents and/or non-functional reactive diluents) and/or non-reactive diluents). Epoxy resin portions may comprise at least one epoxy resin, at least one diluent, or any combination thereof, as listed in Table 3. The epoxy resin portion may further comprise at least one emulsifying agent, weighting agent, the like, or any combination thereof.

Epoxy resin systems of the present disclosure may include various quantities of an epoxy resin portion. Epoxy resin systems may include from about 20 wt % to about 99 wt %, including all wt % values and subsets therebetween, of an epoxy resin portion, based on the total weight of the sealant composition (e.g., from about 20 wt % to about 97 wt %, from about 20 wt % to about 95 wt %, from about 20 wt % to about 90 wt %, from about 20 wt % to about 80 wt %, from about 20 wt % to about 70 wt %, from about 20 wt % to about 60 wt %, from about 20 wt % to about 50 wt %, from about 20 wt % to about 40 wt %, from about 20 wt % to about 30 wt %, from about 30 wt % to about 99 wt %, from about 30 wt % to about 97 wt %, from about 30 wt % to about 95 wt %, from about 30 wt % to about 90 wt %, from about 30 wt % to about 80 wt %, from about 30 wt % to about 70 wt %, from about 30 wt % to about 60 wt %, from about 30 wt % to about 50 wt %, from about 30 wt % to about 40 wt %, from about 40 wt % to about 99 wt %, from about 40 wt % to about 97 wt %, from about 40 wt % to about 95 wt %, from about 40 wt % to about 90 wt %, from about 40 wt % to about 80 wt %, from about 40 wt % to about 70 wt %, from about 40 wt % to about 60 wt %, from about 40 wt % to about 50 wt %, from about 50 wt % to about 99 wt %, from about 50 wt % to about 97 wt %, from about 50 wt % to about 95 wt %, from about 50 wt % to about 90 wt %, from about 50 wt % to about 80 wt %, from about 50 wt % to about 70 wt %, from about 50 wt % to about 60 wt %, from about 60 wt % to about 99 wt %, from about 60 wt % to about 97 wt %, from about 60 wt % to about 95 wt %, from about 60 wt % to about 90 wt %, from about 60 wt % to about 80 wt %, from about 60 wt % to about 70 wt %, from about 70 wt % to about 99 wt %, from about 70 wt % to about 97 wt %, from about 70 wt % to about 95 wt %, from about 70 wt % to about 90 wt %, from about 70 wt % to about 80 wt %, from about 80 wt % to about 99 wt %, from about 80 wt % to about 97 wt %, from about 80 wt % to about 95 wt %, from about 80 wt % to about 90 wt %, from about 90 wt % to about 99 wt %, from about 90 wt % to about 97 wt %, or from about 90 wt % to about 95 wt %). Epoxy resin systems may include from about 50 wt % to about 97 wt %, including all wt % values and subsets therebetween, of an epoxy resin portion, based on the total weight of the sealant composition.

As used herein, the term “epoxy equivalent weight,” and grammatical variations thereof, refers to the weight (e.g., of an epoxy resin portion, or an epoxy resin, or a reactive diluent) in grams that contains one equivalent of an epoxy group. The epoxy equivalent weight (e.g., of an epoxy resin portion, or an epoxy resin, or a reactive diluent) is equal to the average molecular weight divided by the average number of epoxy groups in the epoxy resin. Epoxy resin portions of the present disclosure may have various epoxy equivalent weight values selected to enable curing of sealant compositions of the present disclosure into a solidified, rigid cement. Epoxy resin portions may have an epoxy equivalent weight of from about 170 grams of epoxy resin portion per epoxy group equivalent weight (g/eq) to about 350 g/eq, including all g/eq values and subsets therebetween (e.g., from about 180 g/eq to about 300 g/eq, from about 180 g/eq to about 250 g/eq, from about 180 g/eq to about 225 g/eq, from about 180 g/eq to about 200 g/eq, from about 180 g/eq to about 190 g/eq, from about 190 g/eq to about 350 g/eq, from about 190 g/eq to about 300 g/eq, from about 190 g/eq to about 250 g/eq, from about 190 g/eq to about 225 g/eq, from about 190 g/eq to about 200 g/eq, from about 200 g/eq to about 350 g/eq, from about 200 g/eq to about 300 g/eq, from about 200 g/eq to about 250 g/eq, from about 200 g/eq to about 225 g/eq, from about 225 g/eq to about 350 g/eq, from about 225 g/eq to about 300 g/eq, from about 225 g/eq to about 250 g/eq, from about 250 g/eq to about 350 g/eq, or from about 250 g/eq to about 300 g/eq). Epoxy resin portions of the present disclosure may have an epoxy equivalent weight value of from about 180 g/eq to about 225 g/eq.

Alternately, epoxy equivalent weight may be described as an epoxy value. As used herein, the term “epoxy value,” and grammatical variations thereof, generally refers to the number of epoxy equivalents per kilogram (e.g., of an epoxy resin portion, or an epoxy resin, or a reactive diluent) (eq/kg). Epoxy resin portions may have an epoxy value of from about 2.86 eq/kg to about 5.88 eq/kg, including all epoxy value and subsets therebetween (e.g., from about 4.5 eq/kg to about 5.5 eq/kg). The epoxy equivalent weight and the epoxy value may be determined according to ASTM-D1652. Other methods of determining the epoxy value and epoxy equivalent weight may also be used.

### Epoxy Resin

Epoxy resin portions of the present disclosure may include at least one epoxy resin. Epoxy resin portions may include various quantities of at least one epoxy resin. As used herein, the quantity of at least one epoxy resin in an epoxy resin system is the difference between the quantity of the epoxy resin portion, as disclosed herein, and the quantity of any diluents included therein, as disclosed herein. Epoxy resin portions may include from about 70 wt % to about 100 wt %, including all wt % values and subsets therebetween, of at least one epoxy resin, based on the total weight of the epoxy resin portion (e.g., from about 70 wt % to about 99 wt %, from about 70 wt % to about 97 wt %, from about 70 wt % to about 95 wt %, from about 70 wt % to about 90 wt %, from about 70 wt % to about 85 wt %, from about 70 wt % to about 80 wt %, from about 70 wt % to about 75 wt %, from about 75 wt % to about 100 wt %, from about 75 wt % to about 99 wt %, from about 75 wt % to about 97 wt %, from about 75 wt % to about 95 wt %, from about 75 wt % to about 90 wt %, from about 75 wt % to about 85 wt %, from about 75 wt % to about 80 wt %, from about 80 wt % to about 100 wt %, from about 80 wt % to about 99 wt %, from about 80 wt % to about 97 wt %, from about 80 wt % to about 95 wt %, from about 80 wt % to about 90 wt %, from about 80 wt % to about 85 wt %, from about 85 wt % to about 100 wt %, from about 85 wt % to about 99 wt %, from about 85 wt % to about 97 wt %, from about 85 wt % to about 95 wt %, from about 85 wt % to about 90 wt %, from about 90 wt % to about 100 wt %, from about 90 wt % to about 99 wt %, from about 90 wt % to about 97 wt %, from about 90 wt % to about 95 wt %, from about 95 wt % to about 100 wt %, from about 95 wt % to about 99 wt %, from about 95 wt % to about 97 wt %, from about 97 wt % to about 100 wt %, from about 97 wt % to about 99 wt %, or from about 99 wt % to about 100 wt %) (i.e., from about 14 wt % to about 99 wt %, including all wt % values and subsets therebetween, of at least one epoxy resin, based on the total weight of the sealant composition). Epoxy resin portions include from about 50 wt % to about 97 wt %, including all wt % values and subsets therebetween, of one or more epoxy resins, based on the total weight of the epoxy resin portion.

Epoxy resin portions of the present disclosure may include various types of epoxy resins. Epoxy resin portions may include a single epoxy resin or a combination of two or more different epoxy resins. Suitable examples of epoxy resins include, but are not limited to, bisphenol-epichlorohydrin epoxy resins, novolak epoxy resins, and compounds of formula (I):

[(OC₂H₃)—CH₂—O]ₓ—R¹ (I),

wherein R¹ is a hydrocarbyl group (e.g., linear, branched, cyclic, aromatic, or any combination thereof) having a carbon atom number of from about 6 (C6) to about 24 (C24) carbon atoms, including all carbon atom numbers and subsets therebetween (e.g., from about C6 to about C20, from about C6 to about C16, from about C6 to about C12, from about C6 to about C8, from about C8 to about C24, from about C8 to about C20, from about C8 to about C16, from about C8 to about C12, from about C12 to about C24, from about C12 to about C20, from about C12 to about C16, from about C16 to about C24, from about C16 to about C20, from about C20 to about C24); where x is ≥2; derivatives thereof, and any combination thereof.

Epoxy resins may be selected from the group consisting of 1,6-hexanediol diglycidyl ether, 1,4-cyclohexanedimethanol diglycidyl ether, bisphenol-epichlorohydrin epoxy resins, novolak epoxy resins, the like, and any combination thereof. Bisphenol diglycidyl ethers can be prepared by reacting bisphenol (e.g., bisphenol-A, bisphenol-F, or the like) with epichlorohydrin, generally with sodium hydroxide as catalyst. Bisphenol diglycidyl ethers are small molecules with epoxy groups at both ends of the molecule which can undergo reactions of ring opening, crosslinking, and solidification in the presence of curing agents (e.g., amines, anhydrides). When there is sufficient epichlorohydrin and sodium hydroxide catalyst, the product of the reaction is bisphenol diglycidyl ether. However, excessive bisphenol generates linear high molecular weight compounds with hydroxy groups, ether groups, and/or terminal epoxy groups, where ether bonds increase flexibility of the molecule, hydroxy groups enhance chemical reactivity and bonding ability of the molecule, and epoxy groups allow crosslinking of the molecule into a three-dimensional network by reacting with curing agents.

Bisphenol-epichlorohydrin epoxy resins may comprise at least one component selected from the group consisting of bisphenol diglycidyl ethers, epoxy-functional oligomers thereof, epoxy-functional polymers thereof, the like, and any combination thereof. Bisphenol-epichlorohydrin epoxy resins may comprise at least one component selected from the group consisting of bisphenol-A-diglycidyl ethers, bisphenol-F-diglycidyl ethers, epoxy-functional oligomers thereof, epoxy-functional polymers thereof, the like, and any combination thereof.

Novolaks may be prepared from the acid catalyzed reaction of phenols, o-cresol, p-cresol, m-cresol, or bisphenol with formaldehyde. Novolak epoxy resins may be prepared from the subsequent reaction of novolaks with epichlorohydrin. Novolak epoxy resins may be selected from the group consisting of phenol novolak epoxy resins, o-cresol novolak epoxy resins, bisphenol novolak epoxy resins, the like, and any combination thereof. Bisphenol novolak epoxy resins may be selected from the group consisting of bisphenol-A novolak epoxy resins, bisphenol-F novolak epoxy resins, the like, and any combination thereof.

Suitable commercial examples of Bisphenol-A-epichlorohydrin epoxy resins include, but are not limited to, RAZEEN® series epoxy resins (e.g., RAZEEN® LR 2254), and WellLock® series epoxy resins (e.g., WellLock® R1). Suitable commercial examples of cyclohexanedimethanol diglycidyl ether epoxy resins include, but are not limited to, RAZEEN® series epoxy resins (e.g., RAZEEN® LR 2254), and WellLock® series epoxy resins (e.g., WellLock® R2).

Epoxy resins of the present disclosure may have various epoxy equivalent weight values selected to enable curing of sealant compositions of the present disclosure into a solidified, rigid cement. Epoxy resins may have an epoxy equivalent weight of from about 170 grams of epoxy resin per epoxy group equivalent weight (g/eq) to about 350 g/eq, including all g/eq values and subsets therebetween (e.g., from about 180 g/eq to about 300 g/eq, from about 180 g/eq to about 250 g/eq, from about 180 g/eq to about 225 g/eq, from about 180 g/eq to about 200 g/eq, from about 180 g/eq to about 190 g/eq, from about 190 g/eq to about 350 g/eq, from about 190 g/eq to about 300 g/eq, from about 190 g/eq to about 250 g/eq, from about 190 g/eq to about 225 g/eq, from about 190 g/eq to about 200 g/eq, from about 200 g/eq to about 350 g/eq, from about 200 g/eq to about 300 g/eq, from about 200 g/eq to about 250 g/eq, from about 200 g/eq to about 225 g/eq, from about 225 g/eq to about 350 g/eq, from about 225 g/eq to about 300 g/eq, from about 225 g/eq to about 250 g/eq, from about 250 g/eq to about 350 g/eq, or from about 250 g/eq to about 300 g/eq). Epoxy resins of the present disclosure may have an epoxy equivalent weight value of from about 180 g/eq to about 225 g/eq. As used herein, the term “epoxy equivalent weight,” and grammatical variations thereof, refers to the weight of the epoxy resin in grams that contains one equivalent of an epoxy group. The epoxy equivalent weight of the epoxy resin is equal to the molecular weight of the epoxy resin divided by the average number of epoxy groups in the epoxy resin. Epoxy resins may include 1,6-hexanediol diglycidyl ether, which has an epoxy equivalent weight of from 150 g/eq to 170 g/eq and may exhibit a dynamic viscosity of from 20 mPa·s to 30 mPa·s. Epoxy resins may have an epoxy value of from about 2.86 eq/kg to about 5.88 eq/kg, including all epoxy value and subsets therebetween (e.g., from about 4.5 eq/kg to about 5.5 eq/kg). The epoxy equivalent weight and the epoxy value of epoxy resins may be determined according to ASTM-D1652.

Epoxy resins may have a viscosity that allows introduction of sealant compositions having the epoxy resin into a wellbore. When the epoxy resin system is included in a cement-like slurry composition, epoxy resins may have a high viscosity that enables injection of the resin system slurry into a subterranean formation, such as a high-injectivity zone. Epoxy resins may have a viscosity that enables sealant compositions to be transferred into the annulus between the exterior surface of the casing and the formation face of the wellbore, or the annulus between the interior surface of an outer casing and the exterior surface of an inner casing surrounded by the outer casing.

Epoxy resins of the present disclosure may have an epoxy value of from about 4.76 eq/kg to about 5.26 eq/kg (i.e., an epoxy equivalent weight of from about 190 g/eq to about 210 g/eq) and exhibit a dynamic viscosity of from 600 millipascal seconds (mPa·s) to 1200 mPa·s, or 600 mPa·s to 900 mPa·s. Epoxy resins may have an epoxy equivalent weight of from 270 g/eq to 305 g/eq and may exhibit a dynamic viscosity of from 5 mPa·s to 12 mPa·s. Epoxy resins may have an epoxy equivalent weight of from 170 g/eq to 190 g/eq and exhibit a dynamic viscosity of from 7 mPa·s to 10 mPa·s.

### Diluents

Epoxy resin portions may further include a reactive diluent, a non-reactive diluent, or any combination thereof. As used herein, the term “reactive diluent” refers to a diluent that participated in a chemical reaction during reaction of the epoxy resin, as compared to a “non-reactive diluent,” which refers to a diluent that does not participate in a chemical reaction during reaction of the epoxy resin. The type and amount of reactive and/or non-reactive diluent may influence the viscosity, flexibility, hardness, chemical resistance, mechanical properties, plasticizing effect, reactivity, crosslinking density, or other properties of the epoxy resin. Reactive diluents and/or non-reactive diluents may be added to the epoxy resin portion to change the viscosity of the epoxy resin, such as to reduce the viscosity of the epoxy resin. Reactive diluents and/or non-reactive diluents may be added to epoxy resin portions to improve at least one of the adhesion, the flexibility, and the solvent resistance of the epoxy resin.

Reactive diluents can be functional reactive diluents or non-functional reactive diluents. As used in relation to reactive diluents, the term “functional” refers to a reactive diluent having at least one epoxide functional group (e.g., a mono-functional, di-functional, or multi-functional diluent). Thus, a reactive diluent may have one, two, three, or more than three epoxide functional groups. The term “non-functional,” as used in relation to a reactive diluent, refers to a reactive diluent that does not have at least one epoxide functional group. Thus, a non-functional reactive diluent does not have at least one epoxide functional group, but still participates in at least one chemical reaction during reaction of the epoxide resin with the nitrogenous curing agent. Epoxy resin portions may include a functional reactive diluent, a non-functional reactive diluent, a non-functional diluent, or any combination thereof.

Epoxy resin systems may comprise various types of functional reactive diluents. Suitable examples of functional reactive diluents include, but are not limited to: a compound of formula (I), wherein R¹ is a hydrocarbyl group having a carbon atom number of from about 2 (C2) to about 5 (C5), including all carbon atom values and subsets therebetween (e.g., from about C2 to about C4, from about C2 to about C3, from about C3 to about C5, from about C3 to about C4, or from about C4 to about C5); a compound of formula (II):

(OC₂H₃)—CH₂—R² (II),

where R² is a hydrocarbyl group (e.g., linear, branched, cyclic, aromatic, or any combination thereof) having a carbon atom number of from about 4 (C4) to about 24 (C24) carbon atoms, including all carbon atom numbers and subsets therebetween (e.g., from about C4 to about C20, from about C4 to about C16, from about C4 to about C12, from about C4 to about C8, from about C4 to about C6, from about C6 to about C24, from about C6 to about C20, from about C6 to about C16, from about C6 to about C12, from about C6 to about C8, from about C8 to about C24, from about C8 to about C20, from about C8 to about C16, from about C8 to about C12, from about C12 to about C24, from about C12 to about C20, from about C12 to about C16, from about C16 to about C24, from about C16 to about C20, from about C20 to about C24); derivatives thereof; and any combination thereof.

R² may be selected from the group consisting of a tolyl group, an alkyl group, a cardanol group, derivatives thereof, and any combinations thereof. Examples of functional reactive diluents may include, but are not limited to, propylene glycol diglycidyl ether, butanediol diglycidyl ether, cardanol glycidyl ether derivatives, propanetriol triglycidyl ether, alkyl glycidyl ethers (e.g., C12-14 alkyl glycidyl ethers, C13-C15 alkyl glycidyl ethers, or the like), 2,3-epoxypropyl o-tolyl ether, and any combinations thereof. The compound of formula (II) may be a C12-C14 alkyl glycidyl ether, also referred to herein as “oxirane mono [(C12-C14)-alkyloxy)methyl]derivatives.” Suitable commercial examples of C12-C14 alkyl glycidyl ether reactive diluent include, but are not limited to, RAZEEN® series reactive diluents (e.g., RAZEEN® 7106).

Addition of functional reactive diluent may increase the epoxy equivalent weight of the epoxy resin portion to a value sufficient to enable curing of sealant compositions of the present disclosure into a solidified, rigid cement. Epoxy resin portions comprising epoxy resin and functional reactive diluent may have an epoxy equivalent weight of from about 170 grams of epoxy resin portion per equivalent weight of an epoxy group (g/eq) to about 350 g/eq, including all g/eq values and subsets therebetween (e.g., from about 180 g/eq to about 300 g/eq, from about 180 g/eq to about 250 g/eq, from about 180 g/eq to about 225 g/eq, from about 180 g/eq to about 200 g/eq, from about 180 g/eq to about 190 g/eq, from about 190 g/eq to about 350 g/eq, from about 190 g/eq to about 300 g/eq, from about 190 g/eq to about 250 g/eq, from about 190 g/eq to about 225 g/eq, from about 190 g/eq to about 200 g/eq, from about 200 g/eq to about 350 g/eq, from about 200 g/eq to about 300 g/eq, from about 200 g/eq to about 250 g/eq, from about 200 g/eq to about 225 g/eq, from about 225 g/eq to about 350 g/eq, from about 225 g/eq to about 300 g/eq, from about 225 g/eq to about 250 g/eq, from about 250 g/eq to about 350 g/eq, or from about 250 g/eq to about 300 g/eq).

Epoxy resin portions may include an amount of diluent that reduces the viscosity of the epoxy resin. Epoxy resin portions may include an amount of diluent that modifies one or more of the adhesion, the flexibility, or the solvent resistance of the epoxy resin. Epoxy resin portions may include from 1 wt % to 30 wt % diluent, including all wt % values and subsets therebetween, based on the total weight of the epoxy resin portion (e.g., from about 1 wt % to about 20 wt %, from about 1 wt % to about 15 wt %, from about 1 wt % to about 10 wt %, from about 1 wt % to about 5 wt %, from about 5 wt % to about 30 wt %, from about 5 wt % to about 20 wt %, from about 5 wt % to about 15 wt %, from about 5 wt % to about 10 wt %, from about 10 wt % to about 30 wt %, from about 10 wt % to about 20 wt %, from about 10 wt % to about 15 wt %, from about 15 wt % to about 30 wt %, from about 15 wt % to about 20 wt %, from about 20 wt % to about 30 wt %) (i.e., from about 0.2 wt % to about 30 wt %, including all wt % values and subsets therebetween, of diluent, based on the total weight of the sealant composition).

Diluents may further include one or more viscosity modifiers, such as cardanol liquid, polyacrylate flow agents, or combinations of these, to decrease the viscosity of the epoxy resin. Such viscosity modifiers may be reactive, non-reactive, functional, and/non-functional diluents.

### Emulsifiers

Epoxy resin portions may include various types of emulsifiers. As used herein, the term “emulsifier,” and grammatical variations thereof, generally refer to surfactants capable of stabilizing emulsions. Emulsifiers may be used to stabilize oil-in-water emulsions or invert emulsions (i.e., water-in-oil emulsifiers). Emulsifiers may also be used in all-water fluids or all-oil fluids. Emulsifiers may be nonionic emulsifiers, anionic emulsifiers, cationic emulsifiers, or any combination thereof.

Suitable types of emulsifiers may include alkoxylated alkyl phenols (e.g., ethoxylated alkyl phenols), alkoxylated phenols (e.g., ethoxylated phenols), alkyl phenols (e.g., nonyl phenols), fatty acids (e.g., refined tall oil fatty acids), fatty acid salts (e.g., calcium oleate), fatty acid derivatives (e.g., oxidized fatty acids, fatty acid polyamides, and any combination thereof), lecithins (e.g., soya lecithins), glycol ethers (e.g., ethylene glycol monobutyl ether, diethylene glycol monobutyl ether, the like, and any combination thereof), unsaturated fatty alkyl ethoxylate carboxylic acids (e.g., glycolic acid ethoxylate oleyl ether), modified amidoamines, polyolefin amide alkeneamine, the like, or any combination thereof. Fatty acid polyamides may be selected from the group consisting of carboxylic acid terminated polyamides, reaction products of fatty acid (e.g., tall oil fatty acid) and polyamines (e.g., diethylene triamine, tetraethylenepentamine, and/or triethylenetetramine) and optionally anhydrides (e.g., maleic anhydride), and any combination thereof. Polyamides may be full polyamides or partial amides (e.g., ⅔ amides). Emulsifiers of the present disclosure may comprise at least one emulsifier selected from at least one genus and/or species of chemical compounds selected from Table 5.

Suitable emulsifiers may further be dissolved or dispersed in a solvent. Suitable solvents for emulsifiers may include, but are not limited to, water, alcohol (e.g., isopropanol), petroleum oil (e.g., mineral oil, paraffin oil, diesel oil), vegetable oil (e.g., soybean oil), synthetic hydrocarbons (e.g., paraffins, linear α-olefins, poly((α-olefins), internal olefins (e.g., isomerized α-olefins)), glycol ethers (e.g., ethylene glycol monobutyl ether, diethylene glycol monobutyl ether, the like, and any combination thereof), or the like, or any combination thereof. Solvents for emulsifiers of the present disclosure may comprise at least one genus and/or species of chemical compounds selected from Table 5.

Suitable commercial examples of emulsifiers may include AKTAFLO® series emulsifiers (available from Halliburton)(e.g., AKTAFLO®-E, AKTAFLO®-S), BDF® series emulsifiers (available from Halliburton) (e.g., BDF® 535, 536, 537), BAROMUL® emulsifiers (available from Halliburton) (e.g., BAROMUL 303), BROMI-MUL® series emulsifiers (available from Halliburton) (e.g., BROMI-MUL®), DRILTREAT® series emulsifiers (available from Halliburton) (e.g., INSERT), EZ-CORE® series emulsifiers (available from Halliburton) (e.g., EZ-CORE®), EZ MUL® series emulsifiers (available from Halliburton) (e.g., EZ MUL®, EZ MUL® 2F, EZ MUL® NS, EZ MUL® NT, EZ MUL® NT CONCENTRATE), INVERMUL® series emulsifiers (available from Halliburton) (e.g., INVERMUL®, INVERMUL® NT), FACTANT™ series emulsifiers (available from Halliburton) (e.g., FACTANT™), FORTI-MUL® series emulsifiers (available from Halliburton) (e.g., FORTI-MUL®), WITCOMUL® series emulsifiers (available from Halliburton) (e.g., WITCOMUL® 1844), LE MUL® series emulsifiers (available from Halliburton) (e.g., LE MUL®), LE SUPERMUL™ series emulsifiers (available from Halliburton) (e.g., LE SUPERMUL™), PERFOR MUL® series emulsifiers (available from Halliburton) (e.g., PERFOR MUL®), THERMO MUL® series emulsifiers (available from Halliburton) (e.g., THERMO MUL®), TORQ-TRIM® series emulsifiers (available from Halliburton) (e.g., TORQ-TRIM® 22, TORQ-TRIM® II), or the like, or any combination thereof. Emulsifiers of the present disclosure may be selected from at least one commercially available series of emulsifiers selected from Table 5.

Sealant compositions may include various amounts of an emulsifier. Sealant compositions may include from about 0.1 wt % to about 30 wt %, including all wt % values and subsets therebetween, of emulsifier, based on the total weight of the sealant composition (e.g., from about 0.1 wt % to about 20 wt %, from about 0.1 wt % to about 10 wt %, from about 1 wt % to about 30 wt %, from about 1 wt % to about 20 wt %, from about 1 wt % to about 10 wt %, from about 5 wt % to about 30 wt %, from about 5 wt % to about 20 wt %, from about 5 wt % to about 10 wt %, from about 10 wt % to about 30 wt %, from about 10 wt % to about 20 wt %, from about 20 wt % to about 30 wt %).

### Weighting Materials

Epoxy resin portions may include one or more weighting materials. Weighting materials may be used to add density to the sealant compositions, which in turn may assist the placement of said sealant compositions within deep wells and may provide resistance to severe external loads imposed on casings and cements. Weighting materials may be particulate solids having a specific gravity (SG) that increases the density of the sealant composition. Weighting materials may be added to the sealant composition to increase the density of the final cured resin to increase the hydrostatic pressure exerted by the sealant composition on a formation face of the wellbore or an interior surface of an outer casing surrounding an inner casing. The final density of the cured resin may depend on the geology of the subterranean formation in the zone being sealed. For example, a subterranean formation may require sealant compositions having a greater density to support the wellbore and prevent flow of fluids from the subterranean formation into the wellbore during curing of the sealant composition.

Weighting materials may have a specific gravity (SG) of from 2 to 6. Suitable examples of weighting materials may include, but are not limited to, sand, barite (barium sulfate), hematite, calcium carbonate, siderite, ilmenite, silica sand, manganese oxide (MnO), hausmannite (manganese tetraoxide (Mn₃O₄)), zinc oxide, zirconium oxide, iron oxide, fly ash, or any combination of these weighting materials. Sealant compositions may include Mn₃O₄ weighting materials.

Sealant compositions may include an amount of weighting materials that increases the density of the sealant composition. Sealant compositions may include from about 0.1 wt % to about 40 wt %, including all wt % values and subsets therebetween, of weighting material, based on the total weight of the sealant composition (e.g., from about 0.1 wt % to about 30 wt %, from about 0.1 wt % to about 20 wt %, from about 0.1 wt % to about 10 wt %, from about 1 wt % to about 40 wt %, from about 1 wt % to about 30 wt %, from about 1 wt % to about 20 wt %, from about 1 wt % to about 10 wt %, from about 5 wt % to about 40 wt %, from about 5 wt % to about 30 wt %, from about 5 wt % to about 20 wt %, from about 5 wt % to about 10 wt %, from about 10 wt % to about 40 wt %, from about 10 wt % to about 30 wt %, from about 10 wt % to about 20 wt %, from about 20 wt % to about 40 wt %, from about 20 wt % to about 30 wt %, or from about 30 wt % to about 40 wt %). Sealant compositions may include from about 1 wt % to about 40 wt % Mn₃O₄ weighting materials.

### Curing Agent Portion

As used in this disclosure, the term “curing agent portion” refers to the constituents of the epoxy resin system that do not include one or more epoxy resins, or optionally one or more reactive diluents, but includes the nitrogenous curing agent and optionally one or more curing additives, such as accelerators or retarders. Curing agent portions may comprise one or more nitrogenous curing agents of the present disclosure and optionally one or more curing additives of the present disclosure.

Epoxy resin systems of the present disclosure may include a nitrogenous curing agent to transform the epoxy resin into a semi-solid (i.e., elastic) or solid (i.e., rigid) material. Nitrogenous curing agents may include a single type of nitrogenous curing agent or two or more different types of nitrogenous curing agents. In general, setting time can be controlled by varying either the type of nitrogenous curing agents and/or the type of epoxy resins as well as by varying the concentrations of the nitrogenous curing agents and/or the epoxy resins. Curing agents may include any curing agent of the present disclosure. Curing agents may comprise at least one nitrogenous curing agent listed in Table 4.

Nitrogenous curing agents may comprise at least one agent selected from the group consisting of amines, polyamines, amine adducts, polyamine adducts, alkanolamines, polyetheramines, amides, polyamides, polyamide adducts, amidoamines, polyamidoamines, phenalkamines, imidazoles, and combinations of these. Nitrogenous curing agents may comprise at least one agent selected from the group consisting of amine curing agents, polyamine curing agents, amine adduct curing agents, and polyamine adduct curing agents. Amine curing agents may include, but are not limited to, aliphatic amines, aromatic amines, heterocyclic amines, cycloaliphatic amines, and modified cycloaliphatic amines such as cycloaliphatic amines modified by polyacrylic acid. Polyamine curing agents may include, but are not limited to, aliphatic polyamines, cycloaliphatic polyamines, and modified polyamines such as polyamines modified by polyacrylic acid. Amine adduct curing agents may include, but are not limited to, cycloaliphatic amine adducts.

Nitrogenous curing agents may include an amine type curing agent, which helps in building the viscosity and control setting time. Nitrogenous curing agents may include at least one of trimethyl hexamethylene diamine (TMD), diethylenetriamine (DETA), triethylenetetramine (TETA), meta-xylenediamine (MXDA), aminoethylpiperazine (AEP), tetraethylenepentamine (TEPA), polyetheramine, isophoronediamine (IPDA), beta-hydroxyalkyl amide (HAA), diethyl toluene diamine (DETDA), polyoxypropylene diamine, or combinations of these. Nitrogenous curing agents may include at least one of DETA, TETA, TEPA, IPDA, DEDTA, or combinations of these. Nitrogenous curing agents may include tetraethylenepentamine (TEPA). Suitable commercially available curing agents include, but are not limited to, RAZEEN® CURE series curing agents (e.g., RAZEEN® CURE 931), and WellLock series curing agents (e.g., WellLock H1).

Nitrogenous curing agents may comprise an amine value that enables the nitrogenous curing agent to fully cure the epoxy resin system. Amine values of nitrogenous curing agents may indicate an active hydrogen (NH) content of a nitrogenous curing agent. As used herein, the term “amine value” generally refers to the weight in milligrams of potassium hydroxide (KOH) needed to neutralize the NH in 1 gram of the amine curing agent. Nitrogenous curing agents may have an amine value of from about 250 milligrams of KOH per gram (mg KOH/g) to about 1700 mg KOH/g, including all mg KOH/g values and subsets therebetween (e.g., from about 250 mg KOH/g to about 1650 mg KOH/g, from about 250 mg KOH/g to about 1600 mg KOH/g, from about 450 mg KOH/g to about 1700 mg KOH/g, from about 450 mg KOH/g to about 1650 mg KOH/g, from about 450 mg KOH/g to about 1600 mg KOH/g, from about 650 mg KOH/g to about 1700 mg KOH/g, from about 650 mg KOH/g to about 1650 mg KOH/g, or from about 650 mg KOH/g to about 1600 mg KOH/g).

The amine value may be determined by titrating a solution of the nitrogenous curing agent with a dilute acid, such as a 1 N solution of hydrogen chloride (HCl). The amine value may then be calculated from the amount of HCl needed to neutralize the NH in the solution according to Equation 1:

$$\frac{{V}_{HCl} * {N}_{HCl} * {MW}_{KOH}}{W} , \qquad ( 1 )$$

where V_{HCl} is the volume in milliliters of HCl needed to neutralize the amine, N_{HCl} is the normality of HCl used to titrate the amine, MW_{KOH} is the molecular weight of KOH in grams per mole, and W is the weight in grams of the nitrogenous curing agent sample titrated. The amine number of the known pure nitrogenous curing agent may be calculated from Equation 2:

$$\frac{1000 * {MW}_{KOH}}{{MW}_{curing agent}} , \qquad ( 2 )$$

where MW_{KOH} is the molecular weight of KOH in grams per mole, and MW_{curing agent} is the molecular weight of the nitrogenous curing agent in grams per mole.

The nitrogenous curing agent may have an amine hydrogen equivalent weight (AHEW) that enables the nitrogenous curing agent to fully cure the epoxy resin system. The AHEW of nitrogenous curing agents refers to the grams of the nitrogenous curing agent containing 1 equivalent of amine. The AHEW of nitrogenous curing agents may be calculated by dividing the molecular weight of the nitrogenous curing agent in grams per mole by the number of active hydrogens per molecule. Nitrogenous curing agents may have an AHEW of from about 20 grams (g) to about 120 g, including all gram values and subsets therebetween, as determined according to the methods previously described in this disclosure (e.g., from about 20 g to about 115 g, from about 20 g to about 110 g, from about 20 g to about 100 g, from about 40 g to about 120 g, from about 40 g to about 115 g, from about 40 g to about 110 g, from about 40 g to about 100 g, from about 60 g to about 120 g, from about 60 g to about 115 g, or from about 60 g to about 110 g).

Epoxy resin systems of the present disclosure may include various quantities of a nitrogenous curing agent. Epoxy resin systems may include from about 0.1 wt % to about 30 wt %, including all wt % values and subsets therebetween, of a nitrogenous curing agent, based on the total weight of the sealant composition (e.g., from about 0.1 wt % to about 20 wt %, from about 0.1 wt % to about 10 wt %, from about 0.1 wt % to about 2 wt %, from about 0.1 wt % to about 1 wt %, from about 1 wt % to about 30 wt %, from about 1 wt % to about 20 wt %, from about 1 wt % to about 10 wt %, from about 1 wt % to about 5 wt %, from about 1 wt % to about 2 wt %, from about 2 wt % to about 30 wt %, from about 2 wt % to about 20 wt %, from about 2 wt % to about 10 wt %, from about 2 wt % to about 5 wt %, from about 5 wt % to about 30 wt %, from about 5 wt % to about 20 wt %, from about 5 wt % to about 10 wt %, from about 10 wt % to about 30 wt %, from about 10 wt % to about 20 wt %, from about 20 wt % to about 30 wt %).

Sealant composition of the present disclosure may include an amount of a nitrogenous curing agent capable of curing the sealant compositions to a semi-solid state. Sealant compositions may transition from a liquid state to a semi-solid state at room temperature (e.g., about 25 °C). Sealant compositions may include an amount of a nitrogenous curing agent capable of curing the sealant compositions to a semi-solid state in a curing time of from about 4 hours to more than about 9 hours, including all hour values and subsets therebetween (e.g., from about 4 hours to about 9 hours, from about 4 hours to about 8 hours, from about 4 hours to about 7 hours, from about 4 hours to about 6 hours, or 4 hours, 5 hours, 6 hours, 7 hours, 8 hours, or 9 hours).

Sealant compositions may include an amount of a nitrogenous curing agent capable of further curing the sealant composition to a solid state (e.g., a rigid state). Sealant compositions may transition from a liquid state to a semi-solid state to a solid state at subterranean formation temperatures. Sealant compositions may include an amount of a nitrogenous curing agent capable of curing the sealant compositions to a solid state in a curing time of from about 6 hours to more than about 36 hours, including all hour values and subsets therebetween (e.g., from about 3 hours to about 30 hours, from about 6 hours to about 20 hours, from about 6 hours to about 10 hours, from about 6 hours to about 7 hours, from about 7 hours to about 36 hours, from about 7 hours to about 30 hours, from about 7 hours to about 20 hours, from about 7 hours to about 10 hours, from about 10 hours to about 36 hours, from about 10 hours to about 30 hours, from about 10 hours to about 20 hours, from about 20 hours to about 36 hours, from about 20 hours to about 30 hours, or from about 30 hours to about 36 hours).

Sealant compositions may be capable of curing to a semi-solid state at from about 4 hours to about 6 hours and/or to a solid state in from about 7 hours to about 30 hours and includes from about 0.1 wt % to about 20 wt %, including all wt % values and subsets therebetween, of a nitrogenous curing agent, based on the total weight of the sealant composition.

### Curing Additives

While the thickening and setting times of sealant compositions of the present disclosure may be influenced or otherwise accelerated or delayed by adjusting the concentration of the components of the sealant compositions, epoxy resin systems of the present disclosure may also include one or more additives to modify the speed of the reaction between the epoxy resin and the nitrogenous curing agent or to modify other properties of the resin system, such as viscosity, yield point (YP), or other rheological properties. Epoxy resin systems may further include a cure retarding agent to slow down the reaction between the epoxy resin and the nitrogenous curing agent or an accelerator to speed up said reaction. The thickening and setting time of the sealant compositions of the present disclosure must be designed to be sufficiently long to enable performance of drilling operations, cementing operations, fluid loss control operations, enhanced recovery operations, the like, and any combination thereof, e.g., where the sealant compositions remain in a flowable state until the operation is complete. Suitable cure retarding agents may include, but are not limited to lignin, gums, starches, lignosulphonate derivatives, or combinations of these. Suitable accelerators may include, but are not limited to, alcohols, phenols, amino alcohols, amines, or combinations of these.

Sealant compositions may include a type and/or an amount of an accelerator capable of initiating and/or speeding up curing reactions of sealant compositions of the present disclosure. Sealant compositions may include a type and/or an amount of an accelerator which decreases the setting time of the sealant composition from greater than about 12 hours to a cure time in a range of from about 1 hour to about 12 hours. Sealant compositions may include from about 0.01 wt % to about 10 wt %, including all wt % values and subsets therebetween, of an accelerator, based on the total weight of the sealant composition (e.g., from about 0.01 wt % to about 5 wt %, from about 0.01 wt % to about 3 wt %, from about 0.01 wt % to about 1 wt %, from about 0.1 wt % to about 10 wt %, from about 0.1 wt % to about 5 wt %, from about 0.1 wt % to about 3 wt %, from about 0.1 wt % to about 1 wt %, from about 1 wt % to about 10 wt %, from about 1 wt % to about 5 wt %, or from about 1 wt % to about 3 wt %).

### Sealant Compositions

Flowable sealant compositions of the present disclosure are required to be pumpable and suitable for use as a subterranean formation operation fluid, e.g., a drilling fluid, a cementing slurry, the like, or any combination thereof. For example, sealant compositions may be adapted to different downhole conditions by changing the concentrations of the epoxy resin, curing agents, accelerators, cure retarding agents, emulsifiers, or weighting materials in the sealant composition to modify the specific gravity, rheology, fluid loss, mechanical properties, thickening and/or curing time, gas and fluid migration, or other properties of the sealant compositions.

The rheology and density of flowable sealant compositions may be adjusted over a wide range of values depending on the requirement for the well and the downhole conditions of the well. Sealant compositions may have a density that enables the sealant composition to exert hydrostatic pressure on the wellbore wall or interior surface of an outer casing to support the wellbore, prevent fluids from flowing from the subterranean formation into the wellbore, or both. Sealant compositions may have a density of from about 55 pounds per cubic foot (lbm/ft³) to about 170 lbm/ft³, including all lbm/ft³ values and subsets therebetween (e.g., from 55 lbm/ft³ to 150 lbm/ft³, from 55 lbm/ft³ to 130 lbm/ft³, from 55 lbm/ft³ to 110 lbm/ft³, from 55 lbm/ft³ to 90 lbm/ft³, from 60 lbm/ft³ to 170 lbm/ft³, from 60 lbm/ft³ to 150 lbm/ft³, from 60 lbm/ft³ to 130 lbm/ft³, from 60 lbm/ft³ to 110 lbm/ft³, from 60 lbm/ft³ to 90 lbm/ft³, from 80 lbm/ft³ to 170 lbm/ft³, from 80 lbm/ft³ to 130 lbm/ft³, from 80 lbm/ft³ to 110 lbm/ft³, from 90 lbm/ft³ to 150 lbm/ft³, or from 90 lbm/ft³ to 130 lbm/ft³).

Mixing may be done in the lab using a standard API blender for 15 seconds at 4,000 revolutions per minute (rpm) and 35 seconds at 12,000 rpm. The equation of mixing energy for the sealant composition (slurry) is shown in Equation 3:

$$\frac{E}{M} = \frac{k {ω}^{2} t}{V} , \qquad ( 3 )$$

where:
E=Mixing energy (kiloJoules (kJ)),
M=Mass of slurry (kilograms (kg)),
k=6.1×10⁻⁸ ms/s (constant found experimentally),
ω=Rotational speed (radians/second (s⁻¹)),
t=Mixing time (s), and
V=Slurry volume (m³).

The viscosity of sealant compositions may be measured using a standard oilfield viscometer, such as a FANN® Model 35 viscometer manufactured by Fann Instrument Company for example, according to test methods provided in the API Recommended Practice For Field Testing Water-Based Cement Slurries (RP 13B-1/ISO 10414-1:2002). The viscometer may report shear stress readings at various shear rates. The shear stress readings may be reported in units of pounds of force per 100 square feet (lbf/100 ft²). The shear rate is measured in rpm. The viscometer may report shear stress readings at shear rates of at least one of 600 rpm, 300 rpm, 200 rpm, 100 rpm, 6 rpm, or 3 rpm. These shear stress readings may be used to determine the viscosity of sealant compositions at any of the shear rates, using Equation 4, assuming a viscometer with an R1 rotor sleeve, B1 bob, and F1 torsion spring:

$$μ = \frac{300}{N} {θ}_{N} , \qquad ( 4 )$$

where:
μ=viscosity (cP),
N=viscometer speed, shear rate (rpm),
θ_{N}=viscometer reading, shear stress (lbf/100 ft²).

The rheology of sealant compositions may be modeled based on Bingham plastic flow behavior. In particular, sealant compositions having a Saudi Arabian volcanic ash behave as a rigid body at lesser shear stress but flow as a viscous fluid at greater shear stress. The rheological behavior of the resin system may be determined by measuring the shear stress on the resin system at different shear rates, which may be accomplished by measuring the shear stress and/or shear rate on the resin system using a FANN® Model 35 viscometer operated at 3 rpm, 6 rpm, 100 rpm, 200 rpm, 300 rpm, or 600 rpm, for example. A Bingham plastic fluid may be modeled by Equation 5.

$$τ = ( PV ) \dot{γ} + 4.79 YP , \qquad ( 5 )$$

where:
τ=shear stress (dynes per square centimeter (dyne/cm²)),
PV=plastic viscosity (cP),
\dot{γ}=shear rate (s),
YP=yield point (lbf/100 ft²).

The rheology of sealant compositions may be evaluated from the plastic viscosity (PV) and the yield point (YP), which are parameters from the Bingham plastic rheology model. The PV is related to the resistance of the sealant composition to flow due to mechanical interaction between the solids of the mixture and represents the viscosity of the sealant composition extrapolated to infinite shear rate. In other words, the PV is the slope of the shear stress versus shear rate curve of the Bingham plastic model. The PV reflects the type and concentration of the solids in the sealant composition, and a lesser PV is preferred. The PV of the sealant composition may be estimated by measuring the shear stress of the sealant composition using a FANN® Model 35 viscometer at shear rates of 300 rpm and 600 rpm and subtracting the 300 rpm shear stress measurement from the 600 rpm shear stress measurement according to Equation 6.

$$PV = {θ}_{600} - {θ}_{300} , \qquad ( 6 )$$

where:
PV=plastic viscosity (cP),
θ₆₀₀=shear stress viscometer reading at 600 rpm (lbf/100 ft²),
θ₃₀₀=shear stress viscometer reading at 300 rpm (lbf/100 ft²).

The YP represents the shear stress less than which the sealant composition behaves as a rigid body and greater than which sealant compositions flow as a viscous fluid. In other words, the YP represents the amount of stress required to move sealant compositions from a static condition. The yield point is the resistance of initial flow of a fluid, or the stress required in order to move the fluid. It can be simply stated that the yield point is the attractive force among colloidal particles in the resin system mixture. The YP of the sealant composition is correlated with the capacity of the sealant composition to carry rock cuttings through the annulus, which in simplified terms indicates hole-cleaning ability of sealant compositions. The determination of yield points in sealant compositions is important in the overall description of sealant composition flow properties. Yield point affects both the start-up pressure after a temporary shut-down and the void filling properties of sealant compositions during cementing operations. The YP of sealant compositions may be estimated from the PV from Equation 5 by subtracting the PV from Equation 7 from the shear stress of the sealant composition measured at 300 rpm according to Equation 7.

$$YP = {θ}_{300} - PV . \qquad ( 7 )$$

where YP is expressed as a force per area, such as in field units of lbf/100 ft², for example. The YP may be converted to SI units of dyne/cm², as 1 lbf/100 ft²=4.79 dyne/cm².

Sealant compositions may include an epoxy resin portion including at least one epoxy resin and at least one diluent. Epoxy resin portions may include: at least one epoxy resin selected from the group consisting of bisphenol-based epoxy resins, compounds of formula (I), and any combination thereof; and at least one diluent selected from the group consisting of 2,3-epoxypropyl o-tolyl ether, compounds of formula (II), and any combination thereof; wherein at least one of the epoxy resins has an epoxy equivalent weight of from about 170 to about 350 epoxy equivalents per gram; wherein R¹ of the compound of formula (I) is an alkyl group, optionally a hexyl group; and/or wherein R² of the compound of formula (II) is an alkyl group, optionally a C12-C14 alkyl group. Epoxy resin systems may include at least one of 1,6-hexanediol diglycidyl ether epoxy resin, a bisphenol-A epichlorohydrin epoxy resin, a C12-C14 alkyl glycidyl ether reactive diluent, and 2,3-epoxypropyl o-tolyl ether reactive diluent. Epoxy resin system of the present disclosure may include at least one of 1,6-hexanediol diglycidyl ether epoxy resin, a C12-C14 alkyl glycidyl ether reactive diluent, and 2,3-epoxypropyl o-tolyl ether reactive diluent.

Sealant composition of the present disclosure may include an epoxy resin portion including a plurality of epoxy resins and/or a plurality of reactive diluents. Epoxy resin portions may include a combination of bisphenol-A-epichlorohydrin epoxy resin and 1,6-hexanediol diglycidyl ether epoxy resins and a combination of 2,3-epoxypropyl-o-tolyl ether and C12-C14 alkyl glycidyl ether reactive diluents. Epoxy resins may include a mixture of 1,6-hexanediol diglycidyl ether epoxy resin and bisphenol-A-epichlorohydrin epoxy resin, while the reactive diluent may be either 2,3-epoxypropyl o-tolyl ether or C12-C14 alkyl glycidyl ether. Epoxy resins may include either 1,6-hexanediol diglycidyl ether or bisphenol-A-epichlorohydrin epoxy resin, while the reactive diluent may be a combination of 2,3-epoxypropyl o-tolyl ether and C12-C14 alkyl glycidyl ether.

Epoxy resin portions of the present disclosure may include various combinations of epoxy resins and diluents, e.g., reactive diluents, selected to provide the sealant compositions with a desired epoxy equivalent weight and/or a desired viscosity. Epoxy resin portions of the present disclosure may include a combination of bisphenol-based epoxy resins and reactive diluent C12-C14 alkyl glycidyl ether. Bisphenol-epichlorohydrin epoxy resins of the present disclosure (e.g., bisphenol-A-epichlorohydrin epoxy resins, bisphenol-F-epichlorohydrin epoxy resins, or the like, or any combination thereof) may be modified by blending with a reactive diluent (e.g., a C12-C14 alkyl glycidyl ether) to reduce the viscosity of the resin and/or improve the adhesion, flexibility, and solvent resistance of the final resin. A bisphenol-A-epichlorohydrin epoxy resin may be modified with a reactive diluent C12-C14 alkyl glycidyl ether to modify the viscosity of the sealant compositions and/or to provide the sealant composition with a non-crystalizing resin and improved mechanical and chemical resistance compared to compositions without either the bisphenol-A-(epichlorohydrin) epoxy resin or without the reactive diluent C12-C14 alkyl glycidyl ether.

Epoxy resin portions may include from about 80 wt % to about 90 wt %, including all wt % values and subsets therebetween, of bisphenol-A-epichlorohydrin epoxy resin based on the total weight of the epoxy resin portion (e.g., from 80 wt % to 88 wt %, from 80 wt % to 86 wt %, from 80 wt % to 84 wt %, from 82 wt % to 90 wt %, from 82 wt % to 88 wt %, from 82 wt % to 86 wt %, from 82 wt % to 84 wt %, from 84 wt % to 90 wt %, from 84 wt % to 88 wt %, or from 84 wt % to 86 wt %). Epoxy resin portions may further include from 10 wt % to 20 wt %, including all wt % values and subsets therebetween, of C12-C14 alkyl glycidyl ether, based on the total weight of the epoxy resin portion (e.g., from 10 wt % to 18 wt %, from 10 wt % to 16 wt %, from 10 wt % to 14 wt %, from 12 wt % to 20 wt %, from 12 wt % to 18 wt %, from 12 wt % to 16 wt %, from 12 wt % to 14 wt %, from 14 wt % to 20 wt %, from 14 wt % to 18 wt %, or from 14 wt % to 16 wt %.

Epoxy resins may include the bisphenol-A-(epichlorohydrin) epoxy resin and the reactive diluent C12-C14 alkyl glycidyl ether, and the combination may have an epoxy value of from 4.76 epoxy equivalents per kilogram of epoxy resin to 5.26 epoxy equivalents per kilogram of epoxy resin. Epoxy resins comprising the bisphenol-A-(epichlorohydrin) epoxy resin with the reactive diluent C12-C14 alkyl glycidyl ether may have an epoxy equivalent weight of 190 g/eq to 210 g/eq and a dynamic viscosity of from 600 millipascal seconds (mPa·s) to 1200 mPa·s, or 600 mPa·s to 900 mPa·s. Epoxy resins of the present disclosure may include a combination of an epoxy resin and reactive diluent C12-C14 alkyl glycidyl ether, which may have an epoxy equivalent weight of from 270 g/eq to 305 g/eq and may exhibit a dynamic viscosity of from 5 mPa·s to 12 mPa·s. Epoxy resin systems of the present disclosure may include a combination of an epoxy resin and the reactive diluent 2,3-epoxypropyl-o-tolyl ether, and the combination may have an epoxy equivalent weight of from 170 g/eq to 190 g/eq and exhibit a dynamic viscosity of from 7 mPa·s to 10 mPa·s.

Sealant compositions of the present disclosure may include any epoxy portion of the present disclosure and any nitrogenous curing agent of the present disclosure. Epoxy resin systems may include from about 20 wt % to about 97 wt % of bisphenol-A-epichlorohydrin epoxy resin and reactive diluent C12-C14 alkyl glycidyl ether, and from about 1 wt % to about 20 wt % TEPA curing agent, based on the total weight of the sealant composition. Epoxy resin systems may include from about 10 wt % to about 80 wt % bisphenol-A-epichlorohydrin epoxy resin and reactive diluent C12-C14 alkyl glycidyl ether, and from about 10 wt % to about 80 wt % 1,6-hexanediol diglycidyl ether, and from about 1 wt % to about 20 wt % TEPA curing agent, based on the total weight of the sealant composition.

### Solidified Sealant Compositions

Sealant compositions of the present disclosure may generate a flexible, highly elastic material capable of deformation with shape memory or a hard, rigid, cement-like material. Whether sealant compositions are cured to a semi-solid or a solid state, the solidified sealant compositions are capable of sealing the annulus of a wellbore, preventing fluid loss into lost circulation zones of a subterranean formation connected to the wellbore, or any combination thereof. Solidified sealant compositions of the present disclosure may be capable of withstanding a wide range of temperatures and pressures without failing or deteriorating. Failure or deterioration of the solidified sealant compositions may allow liquids or gases to penetrate into or through the solidified sealant compositions. For example, the sealant composition, once solidified, may be capable of withstanding temperatures of from about 20 degrees Celsius (°C) to about 205 °C. The solidified sealant compositions may also be able to withstand temperature cycling within said temperature range. Solidified sealant composition of the present disclosure may also be capable of withstanding pressures of up to 4,000,000 pounds of force per square inch (psi) (1 psi equals 6.89476 kilopascals (kPa)). For example, solidified sealant compositions may be capable of withstanding pressures of from 14 psi to 4,000,000 psi without failing or deteriorating to allow liquids or gases to penetrate into or through the sealant composition.

### Subterranean Operation Fluids

In an aspect, the present disclosure provides a subterranean operation fluid including sealant compositions of the present disclosure, or one or more components thereof. A subterranean operation fluid may be selected from the group consisting of an aqueous-based drilling fluid, an oil-based drilling fluid, a drilling pill, a cementing fluid, and any combination thereof. Subterranean operation fluids may be drilling fluids comprising a base fluid and a sealant composition of the present disclosure. Subterranean operation fluids of the present disclosure may have good properties, such as suitable rheology (e.g., pumpability, delayed thickening time, or the like), suitable for use in a subterranean operation of the present disclosure.

### Methods Related to Sealant Compositions

In an aspect, the present disclosure provides methods of making and/or using sealant compositions, subterranean operation fluids comprising said sealant compositions or components thereof, or any combination thereof. Methods may comprise making and/or using any sealant composition, subterranean operation fluid (e.g., a drilling fluid, a drilling pill, a cementing fluid, the like, or any combination thereof) comprising said sealant compositions or components thereof, or any combination thereof, of the present disclosure. Methods may comprise performance of any subterranean operation of the present disclosure (e.g., a drilling operation, a cementing operation, the like, or any combination thereof). Methods of using said sealant compositions may include: introducing a sealant composition into a wellbore; wherein the sealant composition comprises an epoxy system comprising an epoxy portion comprising at least one epoxy resin and a curing agent portion comprising at least one nitrogenous curing agent; and volcanic ash; and allowing the sealant composition to cure. Sealant compositions may comprise a non-aqueous carrier fluid. Sealant compositions may exclude an aqueous carrier fluid. Sealant compositions may exclude an alkaline silicate, e.g., an alkali metal silicate.

Sealant compositions may be lost circulation material (LCM) compositions. Methods may comprise introducing an LCM composition into a zone of interest within a subterranean formation via the wellbore, and allowing the LCM composition to cure therein. As used herein, the term “zone of interest,” and grammatical variants thereof, refers to a location within a subterranean formation connected via the wellbore, e.g., a depleted zone, a zone of low pressure, a lost circulation zone, a fracture zone, or any combination thereof. Methods may comprise using the LCM composition to control fluid loss from the wellbore into the subterranean formation during any subterranean operation of the present disclosure.

Methods may comprise performing a drilling operation using a drilling fluid comprising a sealant composition of the present disclosure. During typical drilling operations, a drilling fluid of the present disclosure is continuously pumped into a wellbore penetrating a subterranean formation to lubricate the drill bit and also to clear and clean the wellbore and the filings (also referred to as “cuttings”) resulting from drilling. The drilling fluid is then typically pumped from a mud pit into the wellbore and returns again to the surface. An indication that a depleted zone, zone of low pressure, lost circulation zone, or fractured zone has been encountered is when the flow rate of the drilling fluid that returns to the surface is less than the flow rate of the drilling fluid pumped into the wellbore. This reduction or absence of returning drilling fluid is referred to as lost circulation in the context of a drilling operation.

Drilling fluids comprising the sealant compositions of the present disclosure may be used for drilling all or portions of a wellbore. For example, sealant compositions of the present disclosure may be added to the drilling fluid when a depleted zone, a zone of low pressure, a lost circulation zone, or a fractured zone is encountered. Fractured zones may include fractures that are natural or induced, vugular or cavernous, highly permeable, or unconsolidated. Alternatively, sealant compositions of the present disclosure may be included in the drilling fluid regardless of encountering a depleted zone, a zone of low pressure, a lost circulation zone, or a fractured zone.

Drilling fluid, when introduced into the wellbore, will enter a zone of interest, wherein the zone of interest, for example, may be a depleted zone, a zone of low pressure, a lost circulation zone, a fracture zone, or any combination thereof. Activated sealant compositions of the present disclosure may cure or otherwise polymerize to form solidified sealant compositions therein. Heat may be applied to the zone of interest solely due to natural downhole temperatures, thereby increasing the temperature of the activated sealant compositions and accelerating the transition of the activated sealant compositions into solidified sealant compositions in the zone of interest. Heat may additionally be applied to the zone of interest from an external heat source such as a downhole heater (e.g., an immersion heater or a circulation heater).

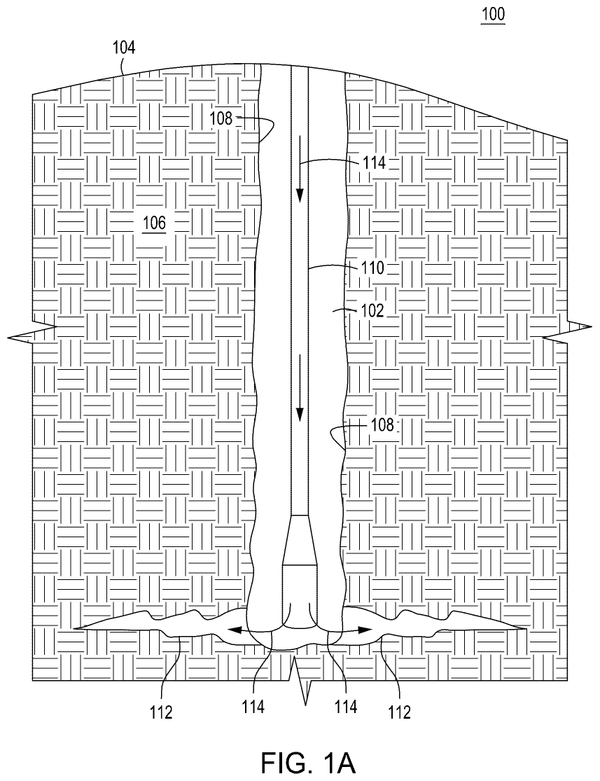

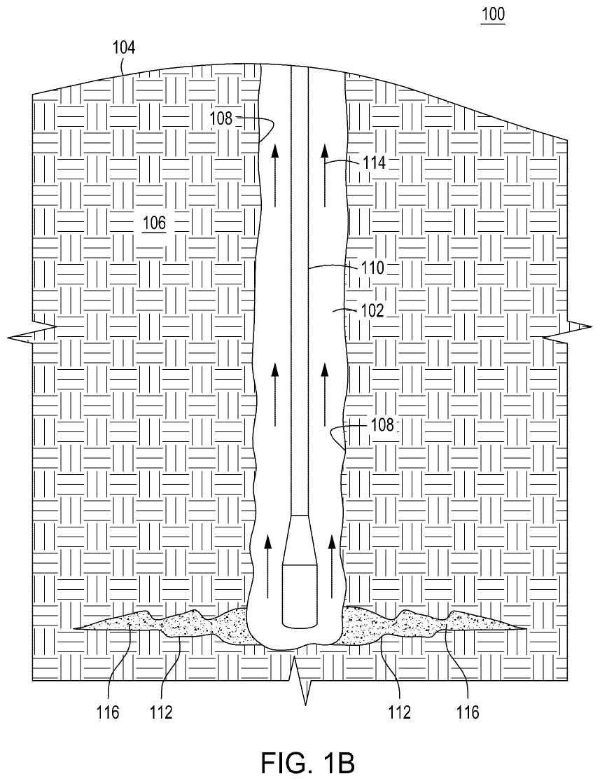

FIGS. 1A-1B illustrate non-limiting examples of a well site 100 having a wellbore 102 through the Earth's surface 104 into a subterranean formation 106 in the Earth's crust. To form the wellbore 102, a hole (i.e., a borehole) may be drilled into the subterranean formation 106 to generate a drilled formation surface 108 as an interface for the wellbore 102 with the subterranean formation 106. The formation surface 108 may be characterized as the wellbore 102 wall. The wellbore 102 may have open hole portions but generally includes a drill string 110. The wellbore 102 may be a cased wellbore 102.

In this nonlimiting example, the wellbore 102 has a lost circulation zone 112 in the subterranean formation 106 at that portion of the wellbore 102. The lost circulation zone 112 causes or contributes to the lost circulation of a fluid 114 (i.e., in this case, a drilling fluid) into the subterranean formation 106. The lost circulation zone 112 has structural features or characteristics which may include, but are not limited to, fractures, voids, vugulars (i.e., vugs), gaps, permeable channels, cavities, cavernous openings, the like, and any combination thereof.

The fluid 114 is introduced from the Earth's surface 104 by flowing downward through the drill string 110 and is discharged from the drill bit as drilling proceeds, and then flows upward through the annulus between the subterranean formation 106 and the drill string 110 toward the Earth's surface 104 as a return fluid. Some or all of the fluid 114 flowing upward through the annulus may be lost through the lost circulation zone 112 into the subterranean formation 106.

FIG. 1B illustrates a non-limiting example of the same well site 100 as described for FIG. 1A, except that a sealant composition 116 of the present application is utilized to treat the lost circulation zone 112 to mitigate (e.g., prevent or reduce) the flow of fluid 114 from the wellbore 102 into the subterranean formation 106. The sealant compositions of the present application may be added to a fluid (i.e., a drilling fluid) and introduced (e.g., pumped) into the wellbore 102. In such cases, sealant compositions of the present application may be added directly to the fluid 114 to be introduced (e.g., pumped) into wellbore 102.

Sealant compositions may be similarly introduced into the zone of interest in the form of a drilling pill, in which an amount of drilling fluid containing the sealant compositions is injected into the wellbore specifically as a lost circulation curing procedure (also referred to herein as “wellbore strengthening” or “wellbore remediation”). In general, a drilling pill may be a relatively small quantity or volume of a carrier fluid, e.g., a drilling fluid, as a specialized blend with sealant compositions utilized for a particular purpose in treating the wellbore 102 or subterranean formation 106.

Once sealant composition 116 enters the lost circulation zone 112, e.g., via fluid 114, the sealant composition 116 may be heated to accelerate setting (e.g., curing or polymerization) of the sealant compositions. For example, sealant composition 116 may be heated to formation temperature conditions as disclosed herein.

Mitigating the flow of liquid from the wellbore may correspond to mitigating the flow of a negligible volume of or all of the volume of the liquid from the wellbore. Mitigation of the flow of fluids may be referred to herein as a “fluidic seal,” in which a barrier is formed to the flow of fluids (e.g., drilling fluids or other fluid types). A fluidic seal may form a barrier having a permeability of less than about 0.1 darcies, including complete sealing such that no fluid passes through the fluidic seal.

Optionally, the sealant compositions may include a component (or additive), as described herein for the breakdown and removal of at least a portion of the fluidic seal. As used herein, the term “at least a portion,” with reference to the breakdown and removal of the fluidic seal, and grammatical variants thereof, refers to restoring the zone of interest (e.g., lost circulation features of 112 of FIGS. 1A-1B) in which the fluidic seal was formed to a permeability no less than about 75% of the original permeability of the target zone.

Methods may further include one or more preparation steps for one or more components of the sealant compositions prior to introducing the sealant compositions to the zone of interest. Preparation steps may include blending at least a portion of the epoxy resin with at least one diluent. Preparation steps may include blending at least a portion of the epoxy resin with at least a portion of the nitrogenous curing agent. Preparation steps may include blending and/or impregnating at least a portion of the volcanic ash with at least a portion of each of the other components of the sealant composition. Preparation steps may include forming a subterranean operation fluid comprising the sealant composition, wherein the subterranean operation fluid is selected from the group consisting of a drilling fluid, a drilling pill, a cementing slurry, and any combination thereof.

Introducing the sealant compositions to the zone of interest may include forming the sealant composition prior to introducing the sealant composition to the zone of interest. Introducing the sealant compositions to the zone of interest may include separately introducing at least one component of the sealant compositions to the zone of interest prior to, concurrently with, or after any other components of the sealant compositions, such that the entire sealant composition is not formed prior to introduction of each of the components to the wellbore and/or to the zone of interest. Introducing the sealant compositions to the zone of interest may include introducing at least one subterranean operation fluid selected from the group consisting of an aqueous-based drilling fluid, an oil-based drilling fluid, a drilling pill, a cementing fluid, and any combination thereof, to the zone of interest, where each component of the sealant compositions is comprised in at least one of the subterranean operation fluids. A single subterranean operation fluid may comprise all components of a sealant composition, which may be prepared prior to or during preparation of the subterranean operation fluid. At least one component of the sealant compositions may be separately included in a different subterranean operation fluid from any of the other components, such that the sealant composition is not formed prior to introduction of each of the different subterranean operation fluids to the wellbore and/or the zone of interest.

### Cementing Operations

In various embodiments, a sealant composition of the present disclosure may be a cementing composition. For a cementing operation, the drill string 110 of FIGS. 1A-1B may be replaced with a casing string 110 (also referred to herein as casing), through which a fluid 114 (i.e., in this case, a cementing fluid or cementing slurry) is introduced from the Earth's surface 104 (i.e., by flowing downward through the casing string 110), is discharged at the bottom of the wellbore 102, and flows upward through the annulus between the subterranean formation 106 and the casing or casing string 110 toward the surface 104, and is allowed to cure into a cement sheath therein. Some or all of the cementing fluid or cementing slurry 114 flowing upward through the annulus may be lost into the subterranean formation 106 through the lost circulation zone 112. A sealant composition 116 of the present application may be utilized to form a cement sheath within the annulus, to treat the lost circulation zone 112 to mitigate (e.g., prevent or reduce) a flow of fluids from the wellbore into the subterranean formation (as shown in FIGS. 1A-1B), or any combination thereof. A cementing fluid or cementing slurry 114 comprising a sealant composition 116 of the present application may be introduced (e.g., pumped) into the wellbore 102, e.g., in a same or different manner than described above for drilling operations.

Other technical features may be readily apparent to one skilled in the art from the following figures, descriptions, and claims.

Embodiments disclosed herein include:

Embodiment 1: A method comprising: introducing a sealant composition into a wellbore within a subterranean formation, wherein the sealant composition comprises: an epoxy resin system comprising: an epoxy resin portion comprising at least one epoxy resin; and at least one nitrogenous curing agent; and a Saudi Arabian volcanic ash; and allowing the sealant composition to cure.

Embodiment 2. The method of Embodiment 1, wherein the sealant composition is introduced into a zone of interest within the subterranean formation via the wellbore, wherein the zone of interest is selected from the group consisting of a depleted zone, a zone of low pressure, a lost circulation zone, a fracture zone, and any combination thereof; and wherein the sealant composition is cured within the lost circulation zone.

Embodiment 3. The method of Embodiment 1, wherein the sealant composition is introduced into the annulus between the wall of the wellbore and a casing disposed therein, and wherein the sealant composition is cured within the annulus.

Embodiment 4. The method of any one of Embodiments 1-3, wherein the at least one epoxy resin comprises a component selected from a group consisting of: bisphenol-epichlorohydrin epoxy resins; novolak epoxy resins; compounds having formula (I): [(OC₂H₃)—CH₂—O]ₓ—R¹, (I), wherein R¹ is a hydrocarbyl group comprising from 6 carbon atoms to 24 carbon atoms, and wherein x is ≥2; derivatives thereof; and any combination thereof; and/or wherein the at least one epoxy resin is present in the sealant composition at from 20 weight percent (wt %) to 99 wt %, based on the total weight of the sealant composition.

Embodiment 5. The method of any one of Embodiments 1-4, wherein the epoxy resin portion further comprises a diluent; wherein the diluent comprises at least one component selected from the group consisting of: compounds having formula (I): [(OC₂H₃)—CH₂—O]ₓ—R¹, (I), wherein R¹ is a hydrocarbyl group comprising 2 carbon atoms to 5 carbon atoms, and wherein x is ≥2; compounds having formula (II): (OC₂H₃)—CH₂—R², (II), where R² is a hydrocarbyl group comprising 4 carbon atoms to 24 carbon atoms; derivatives thereof; and any combination thereof; and/or wherein the diluent is present at from 1 weight percent (wt %) to 10 wt %, based on the total weight of the epoxy resin portion.

Embodiment 6. The method of any one of Embodiments 1-5, wherein the nitrogenous curing agent comprises at least one component selected from the group consisting of amines, polyamines, amine adducts, polyamine adducts, alkanolamines, polyetheramines, amides, polyamides, polyamide adducts, amidoamines, polyamidoamines, phenalkamine, imidazoles, and any combination thereof; and/or wherein the nitrogenous curing agent is present in the sealant composition at from 0.1 weight percent (wt %) to 30 wt %, based on the total weight of the sealant composition.

Embodiment 7. The method of any one of Embodiments 1-6, wherein the Saudi Arabian volcanic ash comprises particles, 80% of which have an average particle size of less than 60 micron (μm); wherein the Saudi Arabian volcanic ash comprises from about 15 weight percent (wt %) to about 30 wt % of Si, and from about 5 wt % to about 15 wt % of Al, based on the total elemental composition of the Saudi Arabian volcanic ash; wherein the Saudi Arabian volcanic ash comprises 70 wt % of amorphous material, at least 15 wt % of labradorite, and at least 5 wt % of each of augite and forsterite; and/or wherein the Saudi Arabian volcanic ash is present in the sealant composition at from 0.1 wt % to 50 wt %, based on the total weight of the sealant composition.

Embodiment 8. The method of any one of Embodiments 1-7, wherein the sealant composition further comprises an emulsifier; and wherein the emulsifier comprises a component selected from a group consisting of alkoxylated alkylphenols; alkoxylated phenols; alkylphenols; fatty acids; fatty amides; polyolefin amide alkenamines; lecithins; glycolic acid alkoxylate alkenyl ethers; glycols; phosphate esters; ethanolamines; N,N-bis(hydroxyethyl) fatty amides; derivatives thereof; and any combination thereof; and/or wherein the emulsifier is present in the sealant composition at from 0.1 weight percent (wt %) to 30 wt %, based on the total weight of the sealant composition.

Embodiment 9. The method of any one of Embodiments 1-8, wherein the sealant composition further comprises a weighting agent; and wherein the weighting agent comprises a component selected from a group consisting of sand, barite, hematite, calcium carbonate, siderite, ilmenite, silica, manganese oxide, hausmannite, manganese tetraoxide, zinc oxide, zirconium oxide, fly ash, and any combination thereof; and/or wherein the weighting agent is present in the sealant composition at from 0.1 weight percent (wt %) to 40 wt %, based on the total weight of the sealant composition.

Embodiment 10. The method of any one of Embodiments 1-9, wherein the sealant composition has a thickening time at 68 degrees Fahrenheit (°F) of from one (1) hour to ten (10) hours; and/or wherein the sealant composition has a setting time of four (4) hours to 40 hours at a temperature of 120 °F.

Embodiment 11. The method of any one of Embodiments 1-10, wherein the method further comprises, prior to introducing the sealant composition, pre-mixing the components of the sealant composition.

Embodiment 12. The method of any one of Embodiments 1-11, wherein the method further comprises, prior to introducing the sealant composition, forming a subterranean operation fluid comprising the sealant composition, wherein the subterranean operation fluid is selected from the group consisting of a drilling fluid, a drilling pill, a cementing slurry, and any combination thereof.

Embodiment 13: A sealant composition comprising: an epoxy resin system comprising: an epoxy resin portion comprising: at least one epoxy resin; and at least one nitrogenous curing agent; and a Saudi Arabian volcanic ash.

Embodiment 14. The sealant composition of Embodiment 13, wherein the at least one epoxy resin comprises a component selected from a group consisting of: bisphenol-epichlorohydrin epoxy resins; novolak epoxy resins; compounds having formula (I): [(OC₂H₃)—CH₂—O]ₓ—R¹, (I), wherein R¹ is a hydrocarbyl group comprising from 6 carbon atoms to 24 carbon atoms, and wherein x is ≥2; derivatives thereof; and any combination thereof; and/or wherein the at least one epoxy resin is present in the sealant composition at from 20 weight percent (wt %) to 99 wt %, based on the total weight of the sealant composition.

Embodiment 15. The sealant composition of Embodiment 13 or Embodiment 14, wherein the epoxy resin portion further comprises a diluent; wherein the diluent comprises at least one component selected from the group consisting of: compounds having formula (I): [(OC₂H₃)—CH₂—O]ₓ—R¹, (I), wherein R¹ is a hydrocarbyl group comprising 2 carbon atoms to 5 carbon atoms, and wherein x is ≥2; compounds having formula (II): (OC₂H₃)—CH₂—R², (II), where R² is a hydrocarbyl group comprising 4 carbon atoms to 24 carbon atoms; derivatives thereof; and any combination thereof; and/or wherein the diluent is present at from 1 weight percent (wt %) to 10 wt %, based on the total weight of the epoxy resin portion.

Embodiment 16. The sealant composition of any one of Embodiments 13-15, wherein the nitrogenous curing agent comprises at least one component selected from the group consisting of amines, polyamines, amine adducts, polyamine adducts, alkanolamines, polyetheramines, amides, polyamides, polyamide adducts, amidoamines, polyamidoamines, phenalkamine, imidazoles, and any combination thereof; and/or wherein the nitrogenous curing agent is present in the sealant composition at from 0.1 weight percent (wt %) to 30 wt %, based on the total weight of the sealant composition.

Embodiment 17. The sealant composition of any one of Embodiments 13-16, wherein the Saudi Arabian volcanic ash comprises particles, 80% of which have an average particle size of less than 60 micron (μm); wherein the Saudi Arabian volcanic ash comprises from about 15 weight percent (wt %) to about 30 wt % of Si, and from about 5 wt % to about 15 wt % of Al, based on the total elemental composition of the Saudi Arabian volcanic ash; wherein the Saudi Arabian volcanic ash comprises 70 wt % of amorphous material, at least 15 wt % of labradorite, and at least 5 wt % of each of augite and forsterite; and/or wherein the Saudi Arabian volcanic ash is present in the sealant composition at from 0.1 wt % to 50 wt %, based on the total weight of the sealant composition.

Embodiment 18. The sealant composition of any one of Embodiments 13-17, wherein the sealant composition further comprises an emulsifier; and wherein the emulsifier comprises a component selected from a group consisting of alkoxylated alkylphenols; alkoxylated phenols; alkylphenols; fatty acids; fatty amides; polyolefin amide alkenamines; lecithins; glycolic acid alkoxylate alkenyl ethers; glycols; phosphate esters; ethanolamines; N,N-bis(hydroxyethyl) fatty amides; derivatives thereof; and any combination thereof; and/or wherein the emulsifier is present in the sealant composition at from 0.1 weight percent (wt %) to 30 wt %, based on the total weight of the sealant composition.

Embodiment 19. The sealant composition of any one of Embodiments 13-18, wherein the sealant composition further comprises a weighting agent, and wherein the weighting agent comprises a component selected from a group consisting of sand, barite, hematite, calcium carbonate, siderite, ilmenite, silica, manganese oxide, hausmannite, manganese tetraoxide, zinc oxide, zirconium oxide, fly ash, and any combination thereof; and/or wherein the weighting agent is present in the sealant composition at from 0.1 weight percent (wt %) to 40 wt %, based on the total weight of the sealant composition.

Embodiment 20. The sealant composition of any one of Embodiments 13-19, wherein the sealant composition has a thickening time at 68 degrees Fahrenheit (°F) of from one (1) hour to ten (10) hours; and/or wherein the sealant composition has a setting time of four (4) hours to 40 hours at a temperature of 120 °F.

To facilitate a better understanding of the aspects of the present disclosure, the following examples of preferred or representative aspects are given. In no way should the following examples be read to limit, or to define, the scope of the disclosure.

### EXAMPLES

### Example 1: Chemical Analysis of the Saudi Arabian Volcanic Ash Sample

Wavelength Dispersive X-ray Fluorescence (WDXRF) may be used to conduct elemental analysis. In WDXRF spectrometers, all of the elements in the sample are excited simultaneously. The different energies of the characteristic radiation emitted from the sample are diffracted into different directions by an analyzing crystal or monochrometer (similar to the action of a prism dispersing different colors of visible light into different directions). By placing the detector at a certain angle, the intensity of X-rays with a certain wavelength can be measured. Sequential spectrometers use a moving detector on a goniometer to move it through an angular range to measure the intensities of many different wavelengths. Simultaneous spectrometers are equipped with a set of fixed detection systems, where each system measures the radiation of a specific element.

For the WDXRF analysis, a sample of Saudi Arabian volcanic ash was homogenized and manually grounded by an agate mortar and a pestle for several minutes to achieve fine particle size. Then, 4 grams of the Saudi Arabian volcanic ash powder was mixed well and homogenized with 0.9 grams of a binder (Licowax C micropowder PM (Hoechstwax)). Then, the powder was pressed with 20 tons of pressure to a pellet with a 31 millimeter (mm) diameter. WDXRF analysis was then performed on the sample using the standardless Omnian 27 method. The WDXRF composition of the Saudi Arabian volcanic ash is shown in Table 1 to be presented. The WDXRF results show that the sample consisted of mainly O and Si with appreciable amounts of Al, Fe, Ca, Mg, and Na.

TABLE 1

| Element | Wt % |
|---|---|
| O | 44.2 |
| Si | 21.8 |
| Al | 8.5 |
| Fe | 8.5 |
| Ca | 6.4 |
| Mg | 4.2 |
| Na | 3.1 |
| Ti | 1.5 |
| K | 1.0 |
| P | 0.3 |
| Mn | 0.1 |

X-ray powder diffraction (XRD) is a rapid analytical technique primarily used for phase identification of a crystalline material and can provide information on unit cell dimensions. The analyzed material is finely ground, homogenized, and average bulk composition is determined. X-ray diffractometers consist of three basic elements: an X-ray tube, a sample holder, and an X-ray detector. X-rays are generated in a cathode ray tube by heating a filament to produce electrons, accelerating the electrons toward a target by applying a voltage, and bombarding the target material with electrons. When electrons have sufficient energy to dislodge inner shell electrons of the target material, characteristic X-ray spectra are produced. These spectra consist of several components, the most common being Kα and Kβ. Kα consists, in part, of Kα1 and Kα2. Kα1 has a slightly shorter wavelength and twice the intensity as Kα2. The specific wavelengths are characteristic of the target material (Cu, Fe, Mo, Cr). Filtering, by foils or crystal monochrometers, is required to produce the monochromatic X-rays needed for diffraction. Kα1 and Kα2 are sufficiently close in wavelength such that a weighted average of the two is used. These X-rays are collimated and directed onto the sample. As the sample and detector are rotated, the intensity of the reflected X-rays is recorded. A detector records and processes this X-ray signal and converts the signal to a count rate which is then output to a device such as a printer or computer monitor.

For the XRD analysis, a sample of Saudi Arabian volcanic ash was homogenized and manually grounded by an agate mortar and a pestle for several minutes to achieve fine particle size. Then, 4 grams of the fine Saudi Arabian volcanic ash powder was mounted into the XRD sample holder by back pressing. XRD was then performed on the sample using the SALAM 014 method. The XRD composition of Saudi Arabian volcanic ash is shown in Table 2.

TABLE 2

| Compound | Wt % |
|---|---|
| Amorphous Material | 70 |
| Labradorite: Ca_{0.65}Na_{0.32}(Al_{1.62}Si_{2.38}O₈) | 19 |
| Augite: Ca(Fe,Mg)Si₂O₆ | 6 |
| Forsterite: Mg₂SiO₄ | 5 |

The XRD results show that the sample consisted mainly of amorphous material with appreciable amounts of labradorite, augite, and forsterite. The WDXRF results confirmed the XRD findings. The volcanic ash sample has a particle size of 80% less than 60 μm.

### Example 2: Formulation and Testing of Sealant Compositions

Table 3 shows possible epoxy resins and diluents for testing. Table 4 shows possible curing agents for testing. Table 5 shows possible emulsifying agents for testing.

TABLE 3

| Epoxy Resin/ | |
|---|---|
| Diluent ID# | |
| (Trade Name) | Epoxy Resin/Diluent Chemical Composition |
| 1 (RAZEEN 2254) | bisphenol-A-epichlorohydrin epoxy resin with the |
| | reactive diluent C12-C14 alkyl glycidyl ether |
| 2 | 2,3-epoxypropyl-o-tolyl ether |
| 3 (RAZEEN 7106) | C12-C14 alkyl glycidyl ether |
| 4 | 1,6-hexanediol diglycidyl ether |
| 5 (WellLock R1) | Bisphenol A/Epichlorohydrin resin and butyl |
| | glycidyl ether |
| 6 | Bisphenol A/Epichlorohydrin and butyl glycidyl |
| | ether and cyclohexanedimethanol diglycidyl ether |
| 7 (WellLock R2) | Cyclohexanedimethanol diglycidyl ether |

TABLE 4

| Curing Agent ID | Chemical Composition |
|---|---|
| 1 (RAZEEN CURE 931) | 90-100% Diethylenetriamine |
| 2 (Well Lock H1) | Diethyltoluenediamine |
| 3 | Polyoxypropylene Diamine |

TABLE 5
Emulsifier Chemical Composition

Oxyethylated alkyl phenol
Carboxylic acid terminated fatty polyamide in biodiesel base
Modified amidoamine
Polyolefin amide alkeneamine
Lecithin liquid dispersion
Refined Tall Oil Fatty Acid (TOFA)
2/3-Amide of TOFA and polyamines, salt
Carboxylic acid terminated fatty polyamide w/C16-18 internal olefin (IO)
Blend of oxidized tall oil and polyaminated fatty acid
Polyaminated fatty acid

Tables 6 and 7 show selected test formulations. Table 8 shows rheology testing of Formulation 1. Table 9 shows the thickening time and setting time for Formulations 1 and 2 at room temperature according to visual observation.

TABLE 6
Formulation#1

| Additive | wt % | Weight (g) | |
|---|---|---|---|
| Resin 1: Razeen ® 2254 | 100% | 100 | g |
| Curing Agent 1: Razeen ® Cure-931 | 2.5% | 2.5 | g |
| Saudi Arabian Volcanic Ash | 16% | 16 | g |

| | |
|---|---|
| Density | 75 pcf |

TABLE 7
Formulation#2

| Additive | wt % | Weight (g) | |
|---|---|---|---|
| Resin 1: Razeen ® 2254 | 100% | 100 | g |
| Curing Agent 1: Razeen ® Cure-931 | 4% | 4 | g |
| Saudi Arabian Volcanic Ash | 9.5% | 9.5 | g |

| | |
|---|---|
| Density | 73 pcf |

TABLE 8

| Rheology | Formulation 1 |
|---|---|
| 300 | Out of range |
| 200 | Out of range |
| 100 | 273 |
| 60 | 163 |
| 30 | 83 |
| 6 | 16 |
| 3 | 7 |
| Note | At room temperature |

TABLE 9

| | Thickening Time (to gelling, | Curing Time (to |
|---|---|---|
| Test sample | viscous, un-pumpable state) | complete rigid material) |
| Formulation 1 | 7 hours | 31 hours |
| Formulation 2 | 4 hours | 7-8 hours |

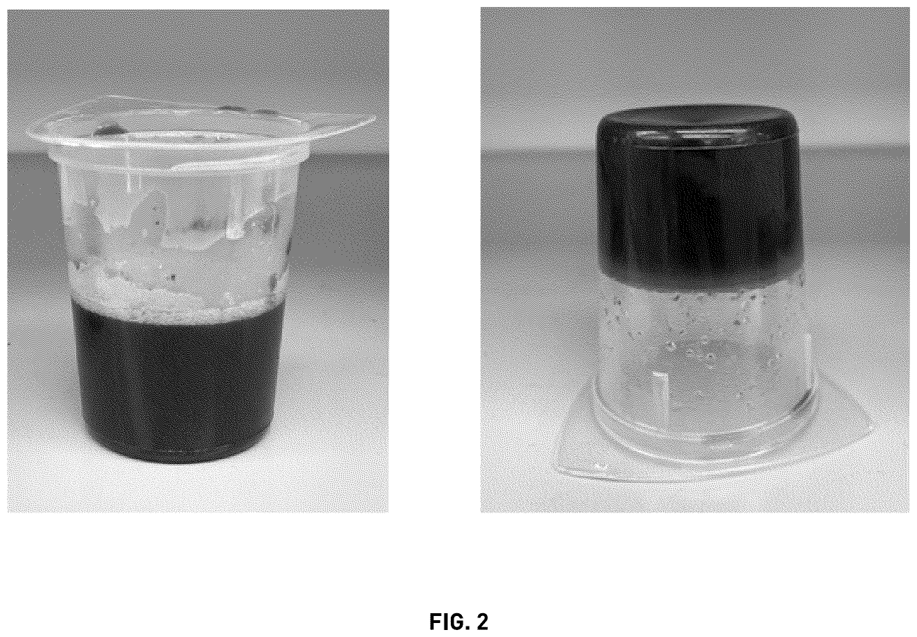

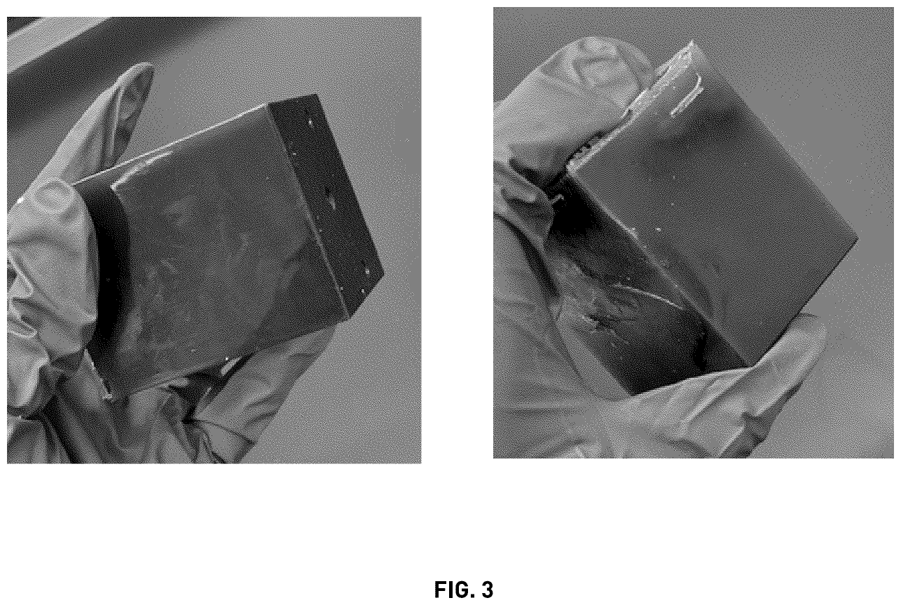

FIG. 2 shows Formulation 2 from Table 7 before and after thickening occurred at room temperature (i.e., the liquid to solid transition observed in Table 9), indicating strong gelling. FIG. 3 shows Formulation 2 after it was kept in a water bath (120 °F) for 24 hours. The formulation was poured into plastic cups and sealed then immersed in the water bath. After 1 day, the sample was removed from the water bath, and the plastic cups removed, to show curing into a hard rigid material.

It is to be recognized that the disclosed drilling fluids may also directly or indirectly affect the various downhole equipment and tools that may come into contact with the fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the well site 100 depicted generally in FIGS. 1A-1B.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

It should be noted that when “about” is provided herein at the beginning of a numerical list, the term modifies each number of the numerical list. In some numerical listings of ranges, some lower limits listed may be greater than some upper limits listed. One skilled in the art will recognize that the selected subset will require the selection of an upper limit in excess of the selected lower limit. Unless otherwise indicated, all numbers expressing quantities of ingredients, properties such as concentration, temperatures, and so forth used in the present specification and associated claims are to be understood as being modified in all instances by the term “about.” As used herein, the term “about” encompasses +/−5% of a numerical value. Accordingly, unless indicated to the contrary, the numerical parameters set forth in the following specification and attached claims are approximations that may vary depending upon the desired properties sought to be obtained by the exemplary embodiments described herein. At the very least, and not as an attempt to limit the application of the doctrine of equivalents to the scope of the claim, each numerical parameter should at least be construed in light of the number of reported significant digits and by applying ordinary rounding techniques.

Terms of orientation are used herein merely for purposes of convention and referencing and are not to be construed as limiting. However, it is recognized these terms could be used with reference to an operator or user.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method comprising:
introducing a sealant composition into a wellbore within a subterranean formation, wherein the sealant composition comprises:
an epoxy resin system comprising:
an epoxy resin portion comprising at least one epoxy resin and a diluent,
wherein the at least one epoxy resin is present at from 70 weight percent (wt %) to 99 wt %, based on the total weight of the epoxy resin portion,
wherein the diluent is present at from 1 weight percent (wt %) to 30 wt %, based on the total weight of the epoxy resin portion, wherein the sealant composition does not comprise an alkaline activator; and
at least one nitrogenous curing agent; and
a Saudi Arabian volcanic ash, wherein the Saudi Arabian volcanic ash comprises particles, 80% of which have an average particle size of less than 60 microns (μm); and
allowing the sealant composition to cure.

2. The method of claim 1, wherein the sealant composition is introduced into a zone of interest within the subterranean formation via the wellbore,
wherein the zone of interest is selected from the group consisting of a depleted zone, a zone of low pressure, a lost circulation zone, a fracture zone, and any combination thereof; and
wherein the sealant composition is cured within the lost circulation zone.

3. The method of claim 1, wherein the sealant composition is introduced into the annulus between the wall of the wellbore and a casing disposed therein, and
wherein the sealant composition is cured within the annulus.

4. The method of claim 1, wherein the at least one epoxy resin comprises a component selected from a group consisting of:
bisphenol-epichlorohydrin epoxy resins;
novolak epoxy resins;
compounds having formula (I):
[(OC₂H₃)—CH₂—O]ₓ—R¹, (I),
wherein R¹ is a hydrocarbyl group comprising from 6 carbon atoms to 24 carbon atoms, and wherein x is ≥2;
derivatives thereof, and
any combination thereof, and/or
wherein the at least one epoxy resin is present in the sealant composition at from 20 weight percent (wt %) to 99 wt %, based on the total weight of the sealant composition.

5. The method of claim 1, wherein the epoxy resin portion further comprises a diluent; wherein the diluent comprises at least one component selected from the group consisting of:
compounds having formula (I):
[(OC₂H₃)—CH₂—O]ₓ—R¹, (I),
wherein R¹ is a hydrocarbyl group comprising 2 carbon atoms to 5 carbon atoms, and wherein x is ≥2;
compounds having formula (II):
(OC₂H₃)—CH₂—R², (II),
where R² is a hydrocarbyl group comprising 4 carbon atoms to 24 carbon atoms; derivatives thereof, and any combination thereof, and/or
wherein the diluent is present at from 1 weight percent (wt %) to 10 wt %, based on the total weight of the epoxy resin portion.

6. The method of claim 1, wherein the nitrogenous curing agent comprises at least one component selected from the group consisting of amines, polyamines, amine adducts, polyamine adducts, alkanolamines, polyetheramines, amides, polyamides, polyamide adducts, amidoamines, polyamidoamines, phenalkamine, imidazoles, and any combination thereof; and/or
wherein the nitrogenous curing agent is present in the sealant composition at from 0.1 weight percent (wt %) to 30 wt %, based on the total weight of the sealant composition.

7. The method of claim 1,
wherein the Saudi Arabian volcanic ash comprises from about 15 weight percent (wt %) to about 30 wt % of Si, and from about 5 wt % to about 15 wt % of Al, based on the total elemental composition of the Saudi Arabian volcanic ash;
wherein the Saudi Arabian volcanic ash comprises 70 wt % of amorphous material, at least 15 wt % of labradorite, and at least 5 wt % of each of augite and forsterite; and/or
wherein the Saudi Arabian volcanic ash is present in the sealant composition at from 0.1 wt % to 50 wt %, based on the total weight of the sealant composition.

8. The method of claim 1, wherein the sealant composition further comprises an emulsifier; and
wherein the emulsifier comprises a component selected from a group consisting of alkoxylated alkylphenols; alkoxylated phenols; alkylphenols; fatty acids; fatty amides; polyolefin amide alkenamines; lecithins; glycolic acid alkoxylate alkenyl ethers; glycols; phosphate esters;
ethanolamines; N,N-bis(hydroxyethyl) fatty amides; derivatives thereof, and any combination thereof; and/or
wherein the emulsifier is present in the sealant composition at from 0.1 weight percent (wt %) to 30 wt %, based on the total weight of the sealant composition.

9. The method of claim 1, wherein the sealant composition further comprises a weighting agent; and
wherein the weighting agent comprises a component selected from a group consisting of sand, barite, hematite, calcium carbonate, siderite, ilmenite, silica, manganese oxide, hausmannite, manganese tetraoxide, zinc oxide, zirconium oxide, fly ash, and any combination thereof; and/or
wherein the weighting agent is present in the sealant composition at from 0.1 weight percent (wt %) to 40 wt %, based on the total weight of the sealant composition.

10. The method of claim 1, wherein the sealant composition has a thickening time at 68 degrees Fahrenheit (°F) of from one (1) hour to ten (10) hours; and/or
wherein the sealant composition has a setting time of four (4) hours to 40 hours at a temperature of 120 °F.

11. The method of claim 1, wherein the method further comprises, prior to introducing the sealant composition, pre-mixing the components of the sealant composition.

12. The method of claim 1, wherein the method further comprises, prior to introducing the sealant composition, forming a subterranean operation fluid comprising the sealant composition, wherein the subterranean operation fluid is selected from the group consisting of a drilling fluid, a drilling pill, a cementing slurry, and any combination thereof.

13. A sealant composition comprising:
an epoxy resin system comprising:
an epoxy resin portion comprising:
at least one epoxy resin; and
at least one nitrogenous curing agent; and
a Saudi Arabian volcanic ash.

14. The sealant composition of claim 13, wherein the at least one epoxy resin comprises a component selected from a group consisting of:
bisphenol-epichlorohydrin epoxy resins;
novolak epoxy resins;
compounds having formula (I):
[(OC₂H₃)—CH₂—O]ₓ—R¹, (I),
wherein R¹ is a hydrocarbyl group comprising from 6 carbon atoms to 24 carbon atoms, and wherein x is ≥2;
derivatives thereof, and
any combination thereof, and/or
wherein the at least one epoxy resin is present in the sealant composition at from 20 weight percent (wt %) to 99 wt %, based on the total weight of the sealant composition.

15. The sealant composition of claim 13, wherein the epoxy resin portion further comprises a diluent;
wherein the diluent comprises at least one component selected from the group consisting of:
compounds having formula (I):
[(OC₂H₃)—CH₂—O]ₓ—R¹, (I)
wherein R¹ is a hydrocarbyl group comprising 2 carbon atoms to 5 carbon atoms, and wherein x is ≥2;
compounds having formula (II):
(OC₂H₃)—CH₂—R², (II)
where R² is a hydrocarbyl group comprising 4 carbon atoms to 24 carbon atoms;
derivatives thereof, and
any combination thereof, and/or
wherein the diluent is present at from 1 weight percent (wt %) to 10 wt %, based on the total weight of the epoxy resin portion.

16. (canceled)

17. The sealant composition of claim 13, wherein the Saudi Arabian volcanic ash comprises particles, 80% of which have an average particle size of less than 60 micron (μm);
wherein the Saudi Arabian volcanic ash comprises from about 15 weight percent (wt %) to about 30 wt % of Si, and from about 5 wt % to about 15 wt % of Al, based on the total elemental composition of the Saudi Arabian volcanic ash;
wherein the Saudi Arabian volcanic ash comprises 70 wt % of amorphous material, at least 15 wt % of labradorite, and at least 5 wt % of each of augite and forsterite; and/or
wherein the Saudi Arabian volcanic ash is present in the sealant composition at from 0.1 wt % to 50 wt %, based on the total weight of the sealant composition.

18. The sealant composition of claim 13, wherein the sealant composition further comprises an emulsifier; and
wherein the emulsifier comprises a component selected from a group consisting of alkoxylated alkylphenols; alkoxylated phenols; alkylphenols; fatty acids; fatty amides; polyolefin amide alkenamines; lecithins; glycolic acid alkoxylate alkenyl ethers; glycols; phosphate esters; ethanolamines; N,N-bis(hydroxyethyl) fatty amides; derivatives thereof, and any combination thereof; and/or
wherein the emulsifier is present in the sealant composition at from 0.1 weight percent (wt %) to 30 wt %, based on the total weight of the sealant composition.

19. The sealant composition of claim 13, wherein the sealant composition further comprises a weighting agent, and
wherein the weighting agent comprises a component selected from a group consisting of sand, barite, hematite, calcium carbonate, siderite, ilmenite, silica, manganese oxide, hausmannite, manganese tetraoxide, zinc oxide, zirconium oxide, fly ash, and any combination thereof; and/or
wherein the weighting agent is present in the sealant composition at from 0.1 weight percent (wt %) to 40 wt %, based on the total weight of the sealant composition.

20. The sealant composition of claim 13, wherein the sealant composition has a thickening time at 68 degrees Fahrenheit (°F) of from one (1) hour to ten (10) hours; and/or
wherein the sealant composition has a setting time of four (4) hours to 40 hours at a temperature of 120 °F.

21. (canceled)
